(19) United States
(12) Patent Application Publication
(10) Pub. No.: US 2023/0365598 A1
(43) Pub. Date: Nov. 16, 2023

(54) DEFLUORINATION OF ORGANO-FLUORINE MOLECUELS BY RARE-EARTH IONS RESULTING IN FLUORO-BRIDGED METAL-ORGANIC FRAMEWORKS

(71) Applicant: Board of Regents, The University of Texas System, Austin, TX (US)

(72) Inventors: Kenneth J. Balkus, The Colony, TX (US); Marie L. MORTENSEN, Lucas, TX (US); Sheybani SIMIN, Austin, TX (US); Juan P. Vizuet, Garland, TX (US)

(21) Appl. No.: 18/303,914

(22) Filed: Apr. 20, 2023

Related U.S. Application Data
(60) Provisional application No. 63/332,742, filed on Apr. 20, 2022.

(51) Int. Cl. C07F 5/00

(52) U.S. Cl. CPC C07F 5/003

(57) ABSTRACT

In one aspect, the disclosure relates to a method for extracting one or more fluorine atoms from an organo-fluorine molecule, the method including at least the step of contacting a rare earth (RE) metal ion with a the organo-fluorine molecule, wherein RE comprises a rare earth metal such as, for example, Ho³⁺, Gd³⁺, Eu³⁺, Dy³⁺, or Y³⁺, and wherein the method produces a fluorinated RE metal organic framework (MOF). In an aspect, the organo-fluorine molecule can be a perfluoroalkyl or polyfluoroalkyl substance (PFAS) and the disclosure provides a method for remediation of PFAS. Also disclosed are novel fluorinated RE MOFs produced by the disclosed methods. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/332,742, filed on Apr. 20, 2022, which is incorporated herein by reference in its entirety.

### BACKGROUND

Since the first reports of porous Metal-Organic Frameworks (MOFs) the field has grown at a rapid pace. The inclusion of Rare-Earth elements (REs) in MOFs is gaining interest, in part because of the unusual coordination environments of REs as well as their optical and electronic properties. In 2013, Xue et al. first introduced the strategy of using fluorinated organic linkers to promote the formation and inclusion of RE hexaclusters in MOFs. The RE ions in the clusters were reported to be bridged by both the linker and μ₃-OH groups. Such hexaclusters were previously observed only in Zr MOFs such as UiO-66. One of the conclusions from this report is that these MOFs would not form if either the linker or a modulator lacked a fluorine group in the α-position relative to the carboxylate. Follow up papers from the same group relied on the use of the modulator 2-fluorobenzoic acid (2-fba) to generate both hexaclusters and nonaclusters. Additionally, the presence of 2-fba allowed for the coordination of these clusters with non-fluorinated organic linkers. The clusters in these MOFs were also reported to be bridged by both the linker and μ₃-OH groups. The use of fluorinated modulators, such as 2-fba or 2,6-dfba, has been widely and successfully implemented in the area of RE MOFs, always with reports of μ₃-OH bridged clusters in their structures.

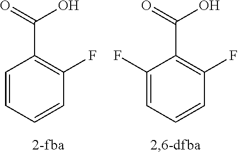

Perfluorinated compounds are extensively used in the manufacturing of a wide array of industrial and commercial products, including a variety of coating applications, such as heat-resistant non-stick utensils, hydrophobic packaging, adhesives, and furniture surfacing. These compounds are remarkably stable under high temperatures, extreme chemical conditions, and in both hydrophilic and hydrophobic environments. The aliphatic C—F bonds are very stable with a bond dissociation energy exceeding 500 kJ mol⁻¹.

According to the Centers for Disease Control and Prevention (CDC) and the United States Environmental Protection Agency (EPA), PFAS contamination in soil and drinking water are becoming a serious environmental threat. The extensive use and disposal of these perfluoroalkyl products have led to environmental contamination and have been detected in the air, drinking water, soil, sediments, wildlife, food, human breast milk, and blood. Their environmental persistence, bioaccumulation, and possible occupational exposure have raised concerns regarding the potential health effects of perfluoroalkyl acids in humans. Several perfluorinated substances have been identified as endocrine-disrupting chemicals based on their ability to interfere with normal reproductive function and hormonal signaling. Given the environmental toxicity and adverse health threats of some fluorochemicals, the development of new methods for their decomposition is important.

PFAS molecules are made of a carbon and fluorine atoms. Because the carbon-fluorine (C—F) bond is among the most chemically robust bonds; the degradation of fluorinated hydrocarbons in the environment is exceptionally difficult. Here, the C—F bond of perfluoroalkyl substances has been cleaved through lanthanide ions. In this method, lanthanide nitrates (Ho³⁺, Gd³⁺, Eu³⁺, Dy³⁺, and the like) in presence of solvents like N,N-dimethylformamide (DMF) or N,N-dimethylacetamide (DMAC) at 120° C. cleaved the C—F bonds of perfluoroalkyl substances such as perfluorohexanoic acid (PFOA) and perfluorooctanoic acid (PFHA) and form the corresponding rare earth fluoride.

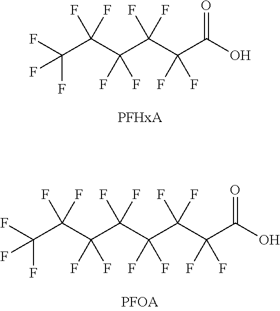 [SMILES: O=C(O)C(F)(F)C(F)(F)C(F)(F)C(F)(F)C(F)(F)F ; O=C(O)C(F)(F)C(F)(F)C(F)(F)C(F)(F)C(F)(F)C(F)(F)C(F)(F)F]

Some methods for decomposition of PFAS based on carbon-fluorine activation in aliphatic fluorides such as monofluoro-, difluoro-, and trifluoro-substituents with inorganic compounds like lithium aluminum hydride (LiAlH₄), organoaluminium reagents such as (Me₃Al, AlCl₃, and Ph₃Al), organolithium reagents, and transition metal catalysts such as Pd, Rh, Ni, Cr (II). These reagents are mostly dangerous, need time-consuming organic procedures to produce, and remove fluorine selectively.

Despite advances in environmental research, there is still a scarcity of compounds that are capable of breaking down PFAS into useful and/or less harmful substances. Furthermore, fluoro bridging groups in RE MOFs are thus far unreported, as are mechanisms of extracting fluorine from 2-fba. These needs and other needs are satisfied by the present disclosure.

### SUMMARY

In accordance with the purpose(s) of the present disclosure, as embodied and broadly described herein, the disclosure, in one aspect, relates to a method for extracting one or more fluorine atoms from an organo-fluorine molecule, the method including at least the step of contacting a rare earth (RE) metal ion with a the organo-fluorine molecule, wherein RE comprises a rare earth metal such as, for example, Ho³⁺, Gd³⁺, Eu³⁺, Dy³⁺, or Y³⁺, and wherein the method produces a fluorinated RE metal organic framework (MOF). In an aspect, the organo-fluorine molecule can be a perfluoroalkyl or polyfluoroalkyl substance (PFAS) and the disclosure provides a method for remediation of PFAS. Also disclosed are novel fluorinated RE MOFs produced by the disclosed methods.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B show the crystal structure of Ho-UiO-66 MOF. FIG. 1A is an extended view along the a direction, while FIG. 1B is a holmium hexacluster containing μ₃-F bridging groups.

FIGS. 2A-2B show the crystal structure of Ho-4,4′-[2,2′-bipyridine]-4,4′-dicarboxylic acid (BPDC) MOF. FIG. 2A is an extended view along the a direction, while FIG. 2B is a holmium tricluster containing one μ₃-F group.

FIGS. 3A-3D show XPS 1 s spectra comparisons between (FIG. 3A) 2-fba, (FIG. 3B) HoF₃, (FIG. 3C) Ho-UiO-66 as synthesized, and (FIG. 3D) Ho-4,4′-BPDC as synthesized.

FIG. 4 shows the crystal structure of compound 1 (Ho). Hydrogen atoms are omitted for clarity.

FIG. 5 shows the asymmetric unit of compound 1 (Ho) with a partial atom numbering scheme.

FIG. 6A shows nonanuclear and trinuclear clusters are connected by the formate ligands, while FIGS. 6B-6C show, respectively, nonanuclear and trinuclear lanthanide-carboxylate-based cluster SBUs containing μ₃-F bridging groups and their peripheral points of extensions.

FIGS. 7A-7B show a comparison of XPS F 1s spectra of (FIG. 7A) 1 (Ho) and (FIG. 7B) activated 2 (Ho) obtained from 1 (Ho).

FIG. 8 shows a comparison of powder X-ray diffraction patterns of 1. The simulated single crystal diffraction pattern, the as-synthesized pattern of 1 (Ho), and the as-synthesized pattern of 1 (Gd) are labeled.

FIG. 9 shows a comparison of powder X-ray diffraction patterns of 2. The simulated single crystal diffraction pattern, the as-synthesized pattern of 2 (Ho) obtained from 1 (Ho), and the as synthesized pattern of 2 (Gd) obtained from 1 (Gd) are labeled.

FIG. 10 shows a 15-c nonanuclear cluster.

FIG. 11 shows a 9-c trinuclear cluster.

FIG. 12 shows a triangular bipyramidal core.

FIG. 13 shows a comparison of powder X-ray diffraction patterns of simulated HoF₃ with the mixture of HoF₃ and layered holmium hydroxide.

FIGS. 14A-14C show XPS spectra of 1 (Ho). (FIG. 14A) survey spectrum, (FIG. 14B) Ho 4d spectrum, (FIG. 14C) F 1s spectrum. The fluorine 1s binding energy is 687.5 eV.

FIGS. 15A-15C show XPS spectra of 2 (Ho) obtained from 1 (Ho) activated at 250° C. (FIG. 15A) survey spectrum, (FIG. 15B) Ho 4d spectrum, (FIG. 15C) F 1s spectrum. The fluorine 1s binding energy is 684.3 eV.

FIGS. 16A-16C show XPS spectra of the 1 (Gd). (FIG. 16A) survey spectrum, (FIG. 16B) Gd 4d spectrum, (FIG. 16C) F 1s spectrum. The fluorine 1s binding energy is 686.8 eV.

FIGS. 17A-17C show XPS spectra of 2 (Gd) obtained from 1 (Gd) activated at 250° C. (FIG. 17A) survey spectrum, (FIG. 17B) Gd 4d spectrum, (FIG. 17C) F 1s spectrum. The fluorine 1s binding energy is 684.5 eV.

FIG. 18 shows powder X-ray diffraction patterns of 2 (Ho) with PFHxA as modulator. The simulated single crystal diffraction pattern, the as-synthesized pattern of 2, and the activated pattern of 2 at 100° C. are labeled.

FIG. 19 shows powder X-ray diffraction patterns of 2 (Gd) with PFHxA as modulator. The simulated single crystal diffraction pattern, the as-synthesized pattern of 2, and the activated pattern of 2 at 100° C. are labeled.

FIG. 20 shows powder X-ray diffraction patterns of 2 (Dy) with PFHxA as modulator. The simulated single crystal diffraction pattern, the as-synthesized pattern of 2, and the activated pattern of 2 at 100° C. are labeled.

FIG. 21 shows powder X-ray diffraction patterns of 2 (Tb) with PFHxA as modulator. The simulated single crystal diffraction pattern, the as-synthesized pattern of 2, and the activated pattern of 2 at 100° C. are labeled.

FIG. 22 shows powder X-ray diffraction patterns of 2 (Ho) with PFOA as modulator. The simulated single crystal diffraction pattern, the as-synthesized pattern of 2, and the activated pattern of 2 at 100° C. are labeled.

FIG. 23 shows powder X-ray diffraction patterns of 2 (Gd) with PFOA as modulator. The simulated single crystal diffraction pattern, the as-synthesized pattern of 2, and the activated pattern of 2 at 100° C. are labeled.

FIG. 24 shows powder X-ray diffraction patterns of 2 (Dy) with PFOA as modulator. The simulated single crystal diffraction pattern, the as-synthesized pattern of 2, and the activated pattern of 2 at 100° C. are labeled.

FIG. 25 shows powder X-ray diffraction patterns of 2 (Tb) with PFOA as modulator. The simulated single crystal diffraction pattern, the as-synthesized pattern of 2, and the activated pattern of 2 at 100° C. are labeled.

FIG. 26 shows powder X-ray diffraction patterns of HoF₃. The simulated single crystal diffraction pattern, the as-synthesized pattern of HoF₃ with PFHxA as modulator, and the as-synthesized pattern of HoF3 with PFOA as modulator are labeled.

FIGS. 27A-27C show XPS spectra of 2 (Ho) with PFHxA as modulator activated at 200° C. (FIG. 27A) survey spectrum, (FIG. 27B) Ho 4d spectrum, (FIG. 27C) F 1s spectrum. The fluorine 1s binding energy is 684.4 eV.

FIGS. 28A-28C show XPS spectra of 2 (Ho) with PFOA as modulator activated at 200° C. (FIG. 28A) survey spectrum, (FIG. 28B) Ho 4d spectrum, (FIG. 28C) F 1s spectrum. The fluorine 1s binding energy is 684.9 eV.

FIGS. 29A-29C show XPS spectra of 2 (Gd) with PFHxA as modulator activated at 200° C. (FIG. 29A) survey spectrum, (FIG. 29A) Gd 4d spectrum, (FIG. 29A) F 1s spectrum. The fluorine 1s binding energy is 684.8 eV.

FIGS. 30A-30C show XPS spectra of 2 (Gd) with PFOA as modulator activated at 200° C. (FIG. 30A) survey spectrum, (FIG. 30B) Gd 4d spectrum, (FIG. 30C) F 1s spectrum. The fluorine 1s binding energy is 684.8 eV.

FIGS. 31A-31C show XPS spectra of 2 (Dy) with PFHxA as modulator activated at 200° C. (FIG. 31A) survey spectrum, (FIG. 31B) Dy 4d spectrum, (FIG. 31C) F 1s spectrum. The fluorine 1s binding energy is 684.9 eV.

FIGS. 32A-32C show XPS spectra of 2 (Dy) with PFOA as modulator activated at 200° C. (FIG. 32A) survey spectrum, (FIG. 32B) Dy 4d spectrum, (FIG. 32C) F 1s spectrum. The fluorine 1s binding energy is 685.4 eV.

FIGS. 33A-33C show XPS spectra of 2 (Tb) with PFHxA as modulator activated at 200° C. (FIG. 33A) survey spectrum, (FIG. 33B) Tb 4d spectrum, (FIG. 33C) F is spectrum. The fluorine 1s binding energy is 684.8 eV.

FIGS. 34A-34C show XPS spectra of 2 (Tb) with PFOA as modulator activated at 200° C. (FIG. 34A) survey spectrum, (FIG. 34B) Tb 4d spectrum, (FIG. 34C) F 1s spectrum. The fluorine 1s binding energy is 684.9 eV.

FIG. 35 shows the F 1s XPS spectra of PFHxA. The fluorine 1s binding energy is 689.2 eV.

FIG. 36 shows TGA of as synthesized Gd-BTB-MOF, Tb-BTB-MOF, Dy-BTB-MOF, and Ho-BTB-MOF with PFHxA as modulator.

FIGS. 37A-37C show the structure of Y-BCA-2D. (FIG. 37A) cluster structure with metal-dimer node, (FIG. 37B) layered structure, and (FIG. 37C) topological representation showing a single layer and stacking.

FIGS. 38A-38D show the crystal structure of Y-BCA-3D. (FIG. 38A) cluster structure with hexanuclear node, (FIG. 38B) c-axis view of hexacluster and isolated Y6F8 cluster, (FIG. 38C) extended 3D network view along the a-axis showing 6.3 Å spherical cavities and (FIG. 38D) underlying net topology of the MOF viewed along the a-axis.

FIGS. 39A-39D show the XPS spectra of (FIG. 39A) Y-BCA-3D survey, (FIG. 39B) Y-BCA-3D high resolution Y 3d_{5/2} and 3d_{3/2}, (FIG. 39C) Y-BCA-2D survey, and (FIG. 39D) Y-BCA-2D high resolution Y 3d_{5/2} and 3d_{3/2}.

FIGS. 40A-40F show high resolution F 1s XPS spectra of (FIG. 40A) 2-FBA, (FIG. 40B) 2,6-DFBA, (FIG. 40C) PFHxA, (FIG. 40D) Y-BCA-3D, (FIG. 40E) YF₃, and (FIG. 40F) physical mixture of Y-BCA-3D and 2,6-DFBA.

FIGS. 41A-41E show adsorption isotherms for (FIG. 41A) Y-BCA-3D and (FIG. 41B) Y-BCA-2D. Representation of sinusoidal voids/channels in Y-BCA-3D (FIG. 41C) viewed along a-axis, (FIG. 41D) viewed along b-axis and gas passage is highlighted by arrows, and (FIG. 41E) viewed along c-axis show presence of deep spherical cavities with a diameter of 6.3 Å.

FIGS. 42A-42B show EDS and map sum spectrum for a MOF having a lover fluorine amount in the structure, with an overall Ho:F ratio of 14.35.

FIGS. 43A-43C show MOF tri clusters with BPDC for Ho (FIG. 43A), Gd (FIG. 43B), and Eu (FIG. 43C). Holmium (III) Nitrate pentahydrate, gadolinium (III) nitrate hexahydrate, or europium (III) nitrate hexahydrate and 2,2′bipyridine-4,4′-dicarboxcylic acid and/or 2-fluorobenzoic acid were dissolved in a mixture of N, N-dimethylformamide and water. Nitric acid was added to help with crystallization. The solution was heated in a vial at 120° C. for 1 day.

FIGS. 44A-44D show details of a Ho-benzene dicarboxylate (BDC) structure with hexaclusters and a formate linker, including a synthetic scheme (FIGS. 44A and 44D). Holmium (III) nitrate pentahydrate and 2-fluorobenzoic acid were dissolved in a solution of N,N-dimethylformamide and water. Nitric acid and formic acid were added to solution. The solution was heated in a vial at 120° C. for 8 hours, and then the linker terephthalic acid was added. The solution continued to heat overnight at 120° C.

FIGS. 45A-45C show a Ho—Cu BPDC mixed metal MOF including synthesis method (FIG. 45C). Holmium (III) nitrate, copper (II) nitrate, 2,2′bipyridine-4,4′-dicarboxcylic acid, 2-fluorobenzoic acid, and 2,2′bipyridine were dissolved in DMF and water. Heat in an autoclave at 120° C. for 1 day.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Methods for Extracting Fluorine from Organo-Fluorine Molecules and Synthesizing Metal Organic Frameworks

In one aspect, disclosed herein is a method for extracting one or more fluorine atoms from an organo-fluorine molecule, the method including at least the step of contacting a rare earth (RE) metal ion or ions with an organo-fluorine molecule. In some aspects, the RE metal ions are provided as a hydrate of RE(NO₃)₃. In another aspect, the method includes contacting the RE metal ions and organo-fluorine molecule with a ligand. In any of these aspects, RE is a rare earth metal and the method produces a fluorinated RE metal organic framework (MOF). In some aspects, the method can be conducted without requiring the formation of any intermediate compounds or compositions, but in another aspect, a first MOF can be synthesized by contacting a RE chloride hydrate with a ligand including, but not limited to, 2,2′-bipyridine, in the presence of 2-fluorobenzoic acid in water. Further in this aspect, the first MOF can be reacted to form a second MOF by contacting with 1,3,5-tris(4-carboxyphenyl)benzene in a solvent composition such as, for example, DMF, H₂O₂, water, HNO₃, acetic acid, or any combination thereof to form fluorine bridges in the MOF.

In an aspect, the organo-fluorine molecule can be a perfluoroalkyl or polyfluoroalkyl substances (PFAS), a benzoic acid derivative having at least one fluorine substituent, or any combination thereof. In a further aspect, when the organo-fluorine molecule is a PFAS, the PFAS can be perfluorooctanoic acid, perfluorohexanoic acid, another PFAS, or any combination thereof.

Further in this aspect, the method can be useful for extracting fluorine molecules from PFAS, thus is useful for assisting with or completing the breakdown and remediation of environmental PFAS.

In an alternative aspect, the benzoic acid derivative having at least one fluorine substituent can be selected from 2-fluorobenzoic acid (2-FBA), 2,6-difluorobenzoic acid (2,6-DFBA), or any combination thereof.

In some aspects, RE can be Ho³⁺, Gd³⁺, Eu³⁺, Dy³⁺, Y³⁺, another rare earth metal, or any combination thereof, while the ligand can be selected from 2,2′-bipyridine, 1,3,5-tris(4-carboxyphenyl)-benzene (H₃BTB), bicinchoninic acid (BCA), or any combination thereof. In one aspect, RE can be Gd³⁺ or Ho³⁺, while the ligand can be H₃BTB. In another aspect, RE can be Y³⁺, while the ligand can be BCA.

In any of these aspects, the method can be carried out in a solvent such as, for example, N,N′-dimethylformamide (DMF), N,N′-diethylformamide (DEF), dimethylacetamide (DMAC), or any combination thereof. In a further aspect, the solvent can also include water, acetic acid, HNO₃, or any combination thereof.

Also disclosed herein, in one aspect, is the use of Y³⁺ to break C—F bonds in organo-fluorine molecules including perfluorohexanoic acid (PFHxA) and form YF₃ or fluoro-bridged hexaclusters in a new MOF, Y-BCA-3D.

In one embodiment, a fluorine-bridged trinuclear cluster is formed with the organic linker [2,2′-bipyridine]-4,4′-dicarboxylic acid (BPDC). In another embodiment, the linker bicinchoninic acid (BCA) can be used to make a new MOF using Y³⁺.

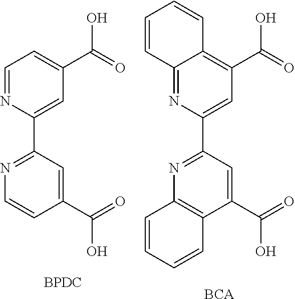

Other linkers useful in the disclosed MOFs include, but are not limited to, those listed and pictured in Table 1:

TABLE 1
Linkers Useful in the Disclosed Methods and/or Found in the Disclosed MOFs

| | |
|---|---|
| 2-fluoro-4-(1H- tetrazol-5-yl) benzoic acid | 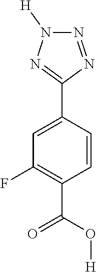 [SMILES: O=C(O)c1ccc(-c2nn[nH]n2)cc1F] |
| 4-(2H-tetrazol-5-yl) benzoic acid | 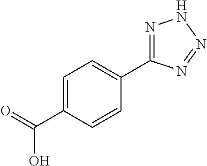 [SMILES: O=C(O)c1ccc(-c2nn[nH]n2)cc1] |
| 4′-cyano-3- fluorobiphenyl-4- carboxylic acid | 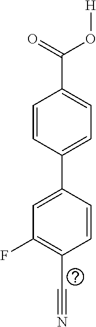 [SMILES: N#Cc1ccc(-c2ccc(C(=O)O)cc2)cc1F] |
| 3,3′- difluorobiphenyl-4,4′- dicarboxylic acid | 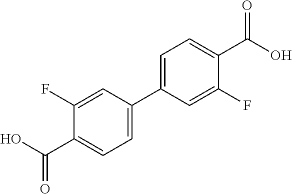 [SMILES: O=C(O)c1ccc(-c2ccc(C(=O)O)c(F)c2)cc1F] |
| 1,4- naphthalenedicarboxylate | 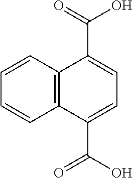 [SMILES: O=C(O)c1ccc(C(=O)O)c2ccccc12] |
| 1,3,5-benzene (tris)benzoate | 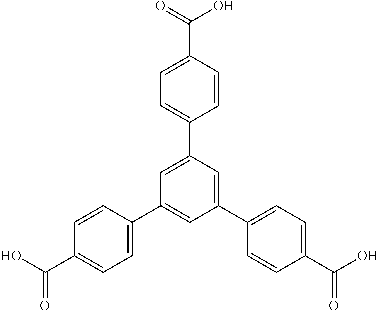 [SMILES: O=C(O)c1ccc(-c2cc(-c3ccc(C(=O)O)cc3)cc(-c3ccc(C(=O)O)cc3)c2)cc1] |
| biphenyl-3,4,5- tricarboxylic acid | 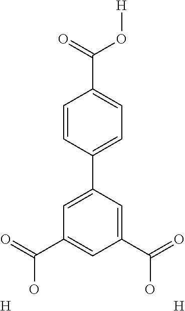 |
| 5-(4- carboxybenzyloxy) isophthalic acid | 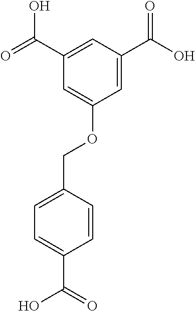 [SMILES: O=C(O)c1ccc(COc2cc(C(=O)O)cc(C(=O)O)c2)cc1] |
| 9-(4- carboxyphenyl)- 9H- carbazole 3,6- dicarboxylic acid | 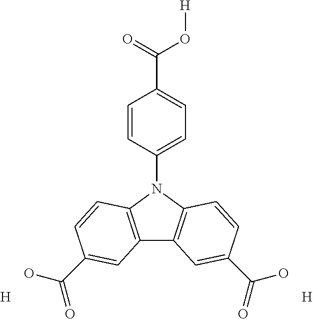 |
| fumaric acid | 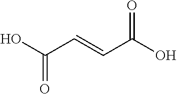 |
| 1,2,4,5- tetrakis[(4- carboxy)phenoxymethyl] benzene | 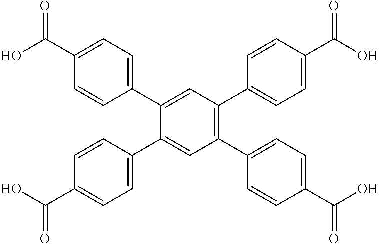 [SMILES: O=C(O)c1ccc(-c2cc(-c3ccc(C(=O)O)cc3)c(-c3ccc(C(=O)O)cc3)cc2-c2ccc(C(=O)O)cc2)cc1] |
| 3,3″,5,5″-tetrakis(4- carboxyphenyl)- p-terphenyl | 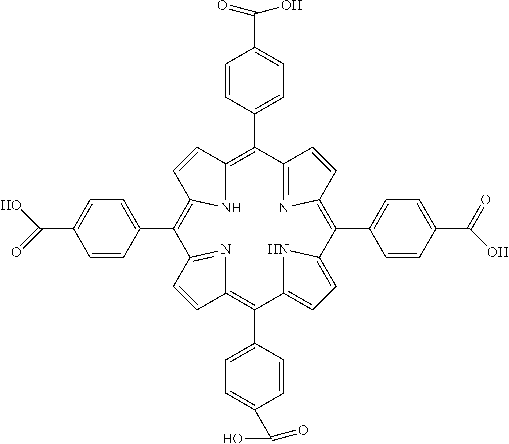 [SMILES: O=C(O)c1ccc(-c2c3nc(c(-c4ccc(C(=O)O)cc4)c4ccc([nH]4)c(-c4ccc(C(=O)O)cc4)c4nc(c(-c5ccc(C(=O)O)cc5)c5ccc2[nH]5)C=C4)C=C3)cc1] |
| 3,3″,5,5″- tetrakis[2-(4- ethoxycarbonylphenyl) ethynyl]- pterphenyl | 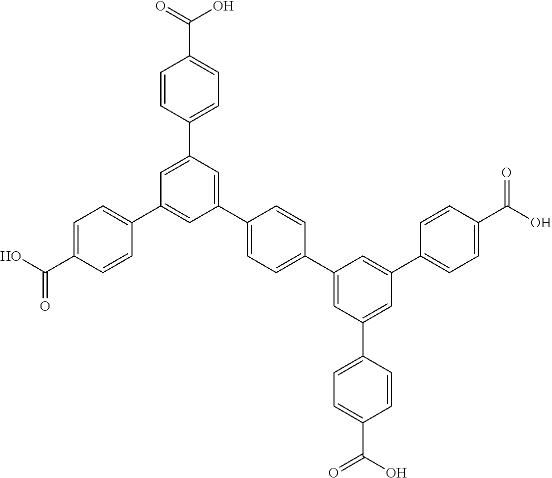 [SMILES: O=C(O)c1ccc(-c2cc(-c3ccc(C(=O)O)cc3)cc(-c3ccc(-c4cc(-c5ccc(C(=O)O)cc5)cc(-c5ccc(C(=O)O)cc5)c4)cc3)c2)cc1] |
| 2- aminoterephthalic acid | 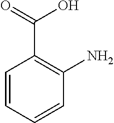 |
| 2- nitroterephthalic acid | 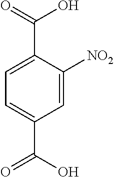 [SMILES: O=C(O)c1ccc(C(=O)O)c([N+](=O)[O-])c1] |
| biphenyl-4,4′- dicarboxylic acid | 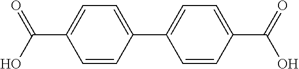 [SMILES: O=C(O)c1ccc(-c2ccc(C(=O)O)cc2)cc1] |
| 2,5- dihydroxyterephthalic acid | 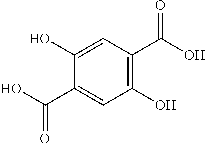 [SMILES: O=C(O)c1cc(O)c(C(=O)O)cc1O] |
| anthracene-2,6- dicarboxylic acid | 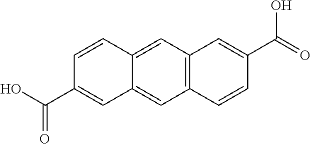 [SMILES: O=C(O)c1ccc2cc3cc(C(=O)O)ccc3cc2c1] |
| naphthlalene-2,6- dicarboxylic acid | 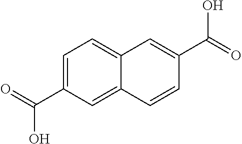 [SMILES: O=C(O)c1ccc2cc(C(=O)O)ccc2c1] |
| pyridine-2,6- dicarboxylic acid | 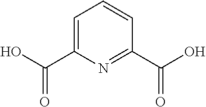 [SMILES: O=C(O)c1cccc(C(=O)O)n1] |
| 4,4′- dicarboxydiphenyl sulfone | 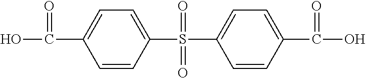 [SMILES: O=C(O)c1ccc(S(=O)(=O)c2ccc(C(=O)O)cc2)cc1] |
| terphenyl-3,3″,5,5″- tetracarboxylic acid | 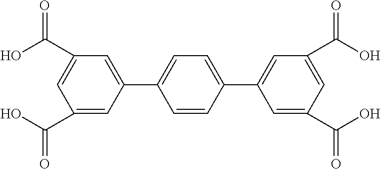 [SMILES: O=C(O)c1cc(C(=O)O)cc(-c2ccc(-c3cc(C(=O)O)cc(C(=O)O)c3)cc2)c1] |
| 3,3′,5,5′- azobenzenetetracarboxylic acid | 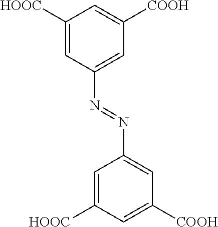 [SMILES: O=C(O)c1cc(/N=N/c2cc(C(=O)O)cc(C(=O)O)c2)cc(C(=O)O)c1] |
| biphenyl-3,3′,5,5′- tetracarboxylic acid | 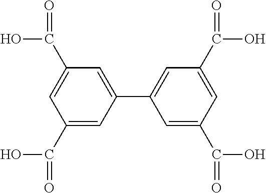 [SMILES: O=C(O)c1cc(C(=O)O)cc(-c2cc(C(=O)O)cc(C(=O)O)c2)c1] |
| 4,4′,4″-((1,3,5- triazine-2,4,6- triyl)tris(azanediyl)) tribenzoic acid | 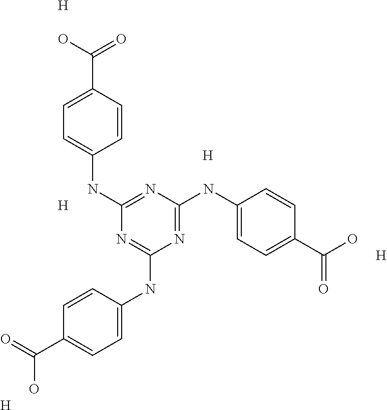 |

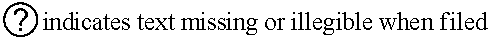

In one aspect, similarly to Ho³⁺, the Y³⁺ ion extracts fluorine from 2-FBA, 2,6-DFBA, as well as PFHxA. In the absence of an organo-fluorine molecule, a new two-dimensional MOF (Y-BCA-2D) can formed.

Also disclosed herein is a method for synthesizing a fluorinated rare earth metal organic framework (MOF), the method including at least the step of contacting a rare earth (RE) metal ion with an organo-fluorine molecule and an organic ligand, where the organo-fluorine molecule can be selected from perfluorooctanoic acid, perfluorohexanoic acid, 2-fluorobenzoic acid (2-FBA), 2,6-difluorobenzoic acid (2,6-DFBA), or any combination thereof, while the organic ligand can be selected from 1,3,5-tris(4-carboxyphenyl)-benzene (H₃BTB), bicinchoninic acid (BCA), or any combination thereof.

In a further aspect, the method can be considered particularly advantageous in that, in addition to remediating PFAS, which are harmful pollutants in the environment, MOFs useful for other purposes are simultaneously formed. In some aspects, RE in the MOF can be Ho³, Gd³⁺, Eu³⁺, Dy³⁺, Y³⁺, another rare earth metal, or any combination thereof. In one aspect, RE can be Gd³⁺ or Ho³⁺, while the ligand can be H₃BTB. In another aspect, RE can be Y³⁺, while the ligand can be BCA. Also disclosed herein are fluorinated rare earth metal organic frameworks produced by the disclosed methods. In an aspect, when RE is Gd³⁺ or Ho³⁺, the rare earth MOF can be a hexagon-shaped crystal having 15-c nonanuclear and 9-c trinuclear cluster MOFs. In an alternative aspect, when RE is Y³⁺, the rare earth can be a tetragon-shaped crystal having hexanuclear clusters.

### MOF Compositions and Properties Thereof

In another aspect, disclosed herein are compositions including at least one MOF structure, the MOF structure selected from among Ho-4,4′-dicarboxylate (Ho-4,4′BPDC), Gd-4,4′-BPDC, Ho-UiO-66, Ho-4,4′-BPDC-2, Cu—Ho-BPDC, Ho-UiO-66-NH₂, Ho-formate-BDC, or a combination thereof. In a further aspect, the MOF structures can be formed by the method including the steps of contacting an organic linker with a fluorine source in the presence of a rare earth metal, wherein the organic linker is 2,2′-bipyridine-4,4′-dicarboxylate (4,4′-BPDC), and the fluorine source is a fluorobenzoic acid having fluorine at the ortho-sites of the benzene ring. In any of these aspects, the method can be carried out in the presence of a solvent such as, for example, DEF (di-ethyl formamide), DMAC (di-methylacetymide), DMF (di-methyl formamide), NMF (Methyl formamide), or any combination thereof. In one aspect, the fluorine source can be selected from 2-fba (2-fluorobenzoic acid), 2,6-fba (2,6-difluorobenzoic acid), or a combination thereof.

In an aspect, the structure resulting from the disclosed synthesis can include one or more RE (rare-earth) triclusters having one μ₃-F group or hexaclusters having at least four μ₃-F groups, the RE tricluster or hexacluster can include one or more elements from the lanthanide series of chemical elements, scandium, yttrium, or any combination thereof. In a further aspect, the RE tricluster or hexacluster can include lanthanum, cerium, praseodymium, neodymium, promethium, samarium, europium, gadolinium, terbium, dysprosium, holmium, erbium, thulium, ytterbium, lutetium, or any combination thereof. In some aspects, the structure does not include a μ₂- or μ₃-OH group, does not include a μ₃ oxo bridge, or both. In a further aspect, two or more clusters can be arranged in a zigzag chain (ladder) pattern along the a-axis of the structure, wherein a rung of the ladder can include one or more Ho—F bonds oriented along the c-axis of the structure. In still another aspect, the structure can include two or more ladders connected to each other through the carboxylate groups of BPDC, along both the a and c directions of the structure.

In an aspect, the RE MOF can include fluoro-bridged clusters, such as, for example, a cluster having an Ho metal center having at least three μ₃-F linkers. In another aspect, the Ho metal center can include at least four carboxylate oxygen atoms, three μ₃-F linkers, and an oxygen atom of a DMF ligand in a distorted square antiprism arrangement.

Also disclosed herein is a method for synthesizing a RE MOF containing fluorine-bridged clusters, the method including the step of extracting one or more fluorine atoms from a fluorine source. In a further aspect, the method can be conducted in a solvent such as, for example, DEF (di-ethyl formamide), DMAC (di-methylacetymide), DMF (di-methyl formamide), and NMF (methylformamide).

Also disclosed herein is a method for synthesizing a metal fluorine composition, the method including at least the steps of extracting one or more fluorine atoms from a fluorine source. In an aspect, the fluorine source can be 2-fba (2-fluorobenzoic acid), 4-fba (4-fluorobenzoic acid), 2,6-fba (2,6-difluorobenzoic acid), a PFAS, or any combination thereof. In a further aspect, the ratios of reactants useful in the disclosed method can vary. Presented herein are exemplary, non-limiting embodiments of ratios that can be useful in the disclosed method. In one aspect, a ratio of 2-fba to metal can be from about 8:1 to about 53:1, or can be about 8:1, 10:1, 15:1, 20:1, 25:1, 30:1, 35:1, 40:1, 45:1, 50:1, 53:1, a range encompassing any of the foregoing, or any combination thereof. In an aspect, when the MOF is Ho-4,4′-BPDC or Gd-4,4′-BPDC, the ratio can be from about 8.33:1 to about 52.63:1.

In another aspect, a 2-fba to metal molar ratio can be from about 12.5:1 to about 25:1, or can be about 12.5:1, 15:1, 20:1, or 25:1, or a range encompassing any of the foregoing, or any combination thereof. Further in this aspect, the MOF can be Cu—Ho-BPDC. In another aspect, when the MOF is Ho-UiO-66, Ho-UiO-66-NH₂, or Ho-formate-BDC, the 2-fba to metal molar ratio can be from about 8.33 to about 10.31.

In some aspects, the 2:fba to metal molar ratio can be selected to synthesize a metal fluoride in the absence of a linker. In a further aspect, this molar ratio can vary by solvent. Thus, in one aspect, in the presence of DMF solvent the molar ratio of 2-fba:Ho is at least 25:1, or in the presence of DMAC solvent the molar ratio of 2-fba:Ho is at least 10.31:1.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a rare earth element,” “a linker,” or “a space group,” includes, but is not limited to, mixtures or combinations of two or more such rare earth elements, linkers, or space groups, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a rare earth metal ion refers to an amount that is sufficient to achieve the desired improvement in the property modulated by the formulation component, e.g. achieving the desired level of deactivation of PFAS. The specific level in terms of wt % in a composition required as an effective amount will depend upon a variety of factors including the surrounding medium, identity of any rare earth metal, available linker molecules, and the chemical identity of the specific PFAS needing to be broken down.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Aspects

The present disclosure can be described in accordance with the following numbered Aspects, which should not be confused with the claims.

Aspect 1. A method for extracting one or more fluorine atoms from an organo-fluorine molecule, the method comprising contacting a hydrate of RE(NO₃)₃ with a ligand in the presence of the organo-fluorine molecule, wherein RE comprises a rare earth metal, and wherein the method produces a fluorinated RE metal organic framework (MOF).

Aspect 2. The method of aspect 1, wherein the organo-fluorine molecule comprises a perfluoroalkyl or polyfluoroalkyl substances (PFAS), a benzoic acid derivative comprising at least one fluorine substituent, or any combination thereof.

Aspect 3. The method of aspect 2, wherein the at least one PFAS comprises perfluorooctanoic acid, perfluorohexanoic acid, or any combination thereof.

Aspect 4. The method of aspect 2, wherein the benzoic acid derivative comprising at least one fluorine substituent comprises 2-fluorobenzoic acid (2-FBA), 2,6-difluorobenzoic acid (2,6-DFBA), or any combination thereof.

Aspect 5. The method of any one of aspects 1-4, wherein RE comprises Ho³⁺, Gd³⁺, Eu³⁺, Dy³⁺, Y³⁺, or any combination thereof.

Aspect 6. The method of any one of aspects 1-5, wherein the ligand comprises 2,2′-bipyridine, 1,3,5-tris(4-carboxyphenyl)-benzene (H₃BTB), bicinchoninic acid (BCA), or any combination thereof.

Aspect 7. The method of any one of aspects 1-6, wherein RE comprises Gd³⁺ or Ho³⁺ and the ligand comprises H₃BTB.

Aspect 8. The method of any one of aspects 1-6, wherein RE comprises Y³⁺ and the ligand comprises BCA.

Aspect 9. The method of any one of aspects 1-8, wherein the method is conducted in a solvent.

Aspect 10. The method of aspect 9, wherein the solvent comprises N,N′-dimethylformamide (DMF), N,N′-diethylformamide (DEF), dimethylacetamide (DMAC), or any combination thereof.

Aspect 11. The method of aspect 9 or 10, wherein the solvent further comprises water, acetic acid, HNO₃, or any combination thereof.

Aspect 12. A method for synthesizing a fluorinated rare earth metal organic framework (MOF), the method comprising contacting a rare earth (RE) precursor with an organo-fluorine molecule and an organic ligand.

Aspect 13. The method of aspect 12, wherein the organo-fluorine molecule comprises perfluorooctanoic acid, perfluorohexanoic acid, 2-fluorobenzoic acid (2-FBA), 2,6-difluorobenzoic acid (2,6-DFBA), or any combination thereof.

Aspect 14. The method of aspect 12 or 13, wherein RE comprises Ho³⁺, Gd³⁺, Eu³⁺, Dy³⁺, Y³⁺, or any combination thereof.

Aspect 15. The method of any one of aspects 12-14, wherein the ligand comprises 1,3,5-tris(4-carboxyphenyl)-benzene (H₃BTB), bicinchoninic acid (BCA), or any combination thereof.

Aspect 16. The method of any one of aspects 12-15, wherein RE comprises Gd³⁺ or Ho³⁺ and the ligand comprises H₃BTB.

Aspect 17. The method of any one of aspects 12-15, wherein RE comprises Y³⁺ and the ligand comprises BCA.

Aspect 18. A fluorinated rare earth metal organic framework (MOF) produced by the method of any one of aspects 12-17.

Aspect 19. The fluorinated rare earth MOF of aspect 18, wherein RE comprises Gd³⁺ or Ho³⁺ and the rare earth MOF comprises a hexagon-shaped crystal comprising 15-c nonanuclear and 9-c trinuclear cluster MOFs.

Aspect 20. The rare earth MOF of aspect 18, wherein RE comprises Y³⁺ and the rare earth MOF comprises a tetragon-shaped crystal comprising hexanuclear clusters.

Aspect 21. A composition comprising a metal-organic framework (MOF) structure, the structure comprising: Ho-4,4′-dicarboxylate (Ho-4,4′BPDC), Gd-4,4′-BPDC, Ho-UiO-66, Ho-4,4′-BPDC-2, Cu—Ho-BPDC, Ho-UiO-66-NH2, Ho-formate-BDC, or a combination thereof.

Aspect 22. The composition of aspect 21, wherein the structure is formed by synthesizing an organic linker and a fluorine source, wherein the organic linker is 2,2′-bipyridine-4,4′-dicarboxylate (4,4′-BPDC), and the fluorine source is a fluorobenzoic acid having fluorine at the ortho-sites of the benzene ring.

Aspect 23. The composition of aspect 21, formed by a solvent including DEF (di-ethyl formamide), DMAC (di-methylacetymide), DMF (di-methyl formamide), NMF (Methyl formamide), or a combination thereof.

Aspect 24. The composition of aspect 21, wherein the fluorine source is 2-fba (2-fluorobenzoic acid), 2,6-fba (2,6-difluorobenzoic acid), or a combination thereof.

Aspect 25. The composition of aspect 21, wherein the fluorine source is 2-fba.

Aspect 26. The composition of aspect 21, wherein the structure comprises one or more RE (rare-earth) triclusters having one μ3-F group or hexaclusters having at least four μ3-F groups, and wherein the RE tricluster or hexacluster includes one or more elements from the lanthanide series of chemical elements, scandium, yttrium, or a combination thereof.

Aspect 27. The composition of aspect 26, wherein the RE tricluster or hexacluster includes lanthanum, cerium, praseodymium, neodymium, promethium, samarium, europium, gadolinium, terbium, dysprosium, holmium, erbium, thulium, ytterbium, lutetium, or a combination thereof.

Aspect 28. The composition of aspect 21, wherein the structure does not include a μ₂- or μ₃-OH group, does not include a μ₃-oxo bridge, or both.

Aspect 29. The composition of aspect 26, wherein two or more clusters are arranged in a zig-zag chain “ladder” pattern along the a-axis of the structure.

Aspect 30. The composition of aspect 26, wherein a rung of the ladder includes one or more Ho—F bonds oriented along the c-axis of the structure.

Aspect 31. The composition of aspect 26, comprising two or more ladders connected to each other through the carboxylate groups of BPDC, along both the a and c directions of the structure.

Aspect 32. A composition comprising a rare-earth (RE) metal-organic framework (MOF) comprising fluoro-bridged clusters.

Aspect 33. The composition of aspect 32, further comprising a Ho metal center having at least three μ3-F linkers.

Aspect 34. The composition of aspect 32, wherein the Ho metal center comprises four carboxylate oxygen atoms, three μ3-F linkers, and an oxygen atom of a DMF ligand in a distorted square antiprism arrangement.

Aspect 35. A method for synthesizing a rare-earth (RE) metal-organic framework (MOF) comprising fluoro-bridged clusters, comprising the step of extracting one or more fluorine atoms from a fluorine source and forming a fluorine-bridged structure.

Aspect 36. The method of aspect 35, wherein the fluorine-bridged structure comprises a RE center.

Aspect 37. The method of aspect 35, further comprising using a solvent selected from the group consisting of: DEF (di-ethyl formamide), DMAC (di-methylacetymide), DMF (di-methyl formamide), and NMF (Methylformamide).

Aspect 38. A method of synthesizing a metal-fluorine composition, comprising extracting one or more fluorine atoms from a fluorine source and forming a metal-fluoride, wherein the fluorine source comprises 2-fba (2-fluorobenzoic acid), 4-fba (4-fluorobenzoic acid), 2,6-fba (2,6-difluorobenzoic acid), or a combination thereof.

Aspect 39. The method of aspect 38, wherein a 2-fba to metal molar ratio (2-fba:M) is selected to not lead to the synthesis of a metal-fluoride, wherein a ratio of 2-fba to metal molar ratio (2-fba:M) is at least 8, and not greater than 53.

Aspect 40. The method of aspect 38, wherein for synthesizing Ho-4,4′-BPDC in DMF solvent, a 2-fba to metal molar ratio (2-fba:Ho) is at least 8.33 and not greater than 52.63.

Aspect 41. The method of aspect 38, wherein for synthesizing Gd-4,4′-BPDC in DMF solvent, a 2-fba to metal molar ratio (2-fba:Gd) is at least 8.33.

Aspect 42. The method of aspect 38, wherein for synthesizing Ho-4,4′-BPDC-2 in DMF solvent, a 2-fba to metal molar ratio (2-fba:Ho) is at least 8.33 and not greater than 52.63.

Aspect 43. The method of aspect 38, wherein for synthesizing Cu—Ho-BPDC in DMF solvent, a 2-fba to metal molar ratio (2-fba:Ho) is at least 12.5 and not greater than 25.

Aspect 44. The method of aspect 38, wherein for synthesizing Ho-UiO-66 in DMAC solvent, a 2-fba to metal molar ratio (2-fba:Ho) is at least 8.33 and not greater than 10.31.

Aspect 45. The method of aspect 38, wherein for synthesizing Ho-UiO-66-NH2 in DMF solvent, a 2-fba to metal molar ratio (2-fba:Ho) is at least 8.33.

Aspect 46. The method of aspect 38, wherein for synthesizing Ho-formate-BDC in DMF solvent, a 2-fba to metal molar ratio (2-fba:Ho) is at least 8.33.

Aspect 47. The method of aspect 38, wherein a 2-fba to metal molar ratio (2-fba:M) is selected to cause the reaction, in the absence of a linker, to synthesize a metal-fluoride.

Aspect 48. The method of aspect 38, wherein a 2-fba to Holmium molar ratio (2-fba:Ho) is selected to cause the reaction, in the absence of a linker, to synthesize a metal-fluoride, wherein in the presence of NMF solvent the molar ratio of 2-fba:Ho is at least 8.33, wherein in the presence of DMF solvent the molar ratio of 2-fba:Ho is at least 25, or wherein in the presence of DMAC solvent the molar ratio of 2-fba:Ho is at least 10.31.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Rare Earth Elements in Porous Metal-Organic Frameworks

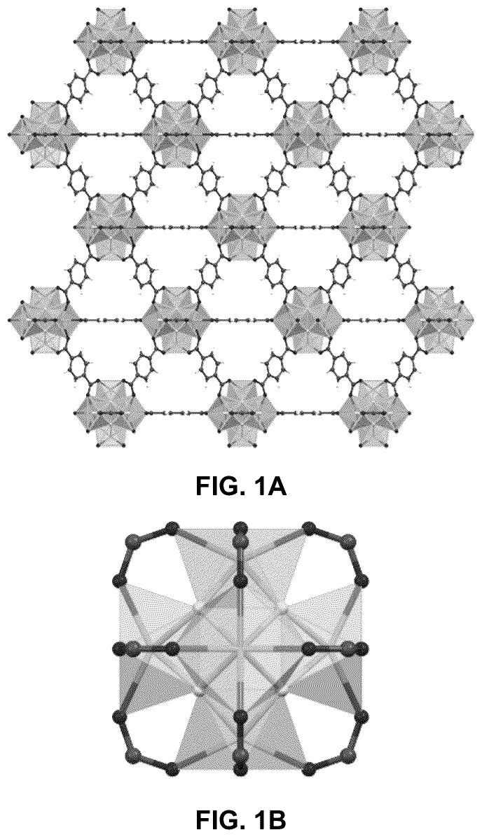

We have previously synthesized holmium-based MOFs (Ho-MOFs), in part because holmium can be neutron activated and used for radiotherapy. Generally, using benzene dicarboxylate (BDC) or related linkers, resulted in MOFs only containing Ho³⁺ dimers. Therefore, 2-fba was tested as a modulator, since the reported clusters in these MOFs impart better stabilities. The 2-fba modulator worked well, producing a Ho-MOF isostructural to UiO-66, in accordance with a recent report of UiO-66 RE-MOFs. Surprisingly, upon closer inspection of the crystallographic data, it was apparent that the holmium ions in the cluster presented fluoro-bridges, and not the reported OH-bridges (FIGS. 1A-1B).

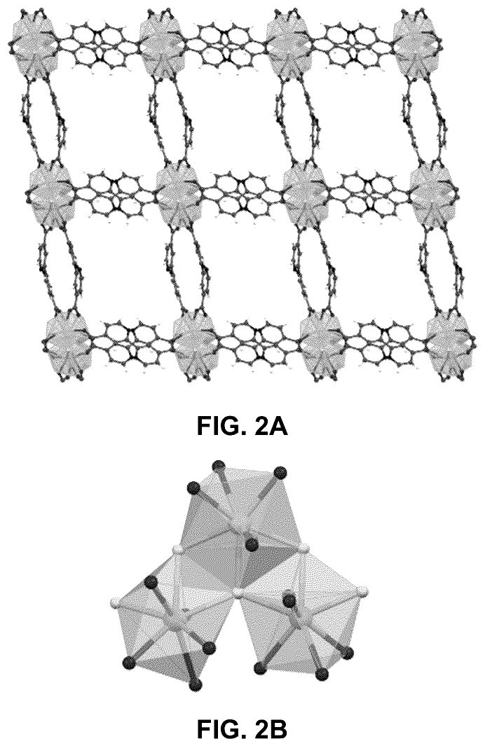

Fluoro-bridges were also observed in another Ho-MOF using the organic linker 2,2′-bipyridine-4,4′-dicarboxylate (4,4′-BPDC) and 2-fba as a modulator. The new structure, reported here for the first time, Ho-4,4′-BPDC MOF contains μ₃-F groups that form holmium trinuclear clusters. These clusters in turn form zig-zag “ladders” that propagate along the a-axis. There is a slight twist to the side-rails of this ladder which cause it to oscillate in-and-out of the ab plane. The rungs of the ladder consist of the Ho—F bonds which orient along the c axis. These chains are connected through the carboxylate groups of BPDC, along both the a and c directions. The pyridine groups in the BPDC linker remain uncoordinated (FIGS. 2A-2B).

The observed fluoro-bridges led to the examination of the crystallographic information files (CIFs) from other RE cluster containing MOFs that used 2-fba or 2,6-dfba in their synthesis. In particular, the first report that used fluorinated linkers or modulators was focused on, since this publication appears to serve as the forerunner to address the anomalies explored in the Examples.

A common feature in all these structures is that the bridging μ₃-OH and/or μ₃-O groups have unusually smaller thermal/displacement ellipsoids and atomic displacement parameters (U_{eq}) than the rare earth metal centers with a higher coordination number. For example, Xue et al. discussed an observable anomaly: an excess of electron density for some of the μ₃-bridges in the RE clusters. This excess electron density has a direct correlation with the decreased size of the thermal/displacement ellipsoids and the decreased U_{eq}. The assumption behind the excess electron density was attributed to the hybridization effect involving the electron transfer from the 4d orbitals of the RE cluster to the 2p orbitals of the coordinated oxygen atoms, as previously described in yttrium oxide cluster anions.49 This assumption led to the assignment of the bridging atomic sites as oxygens, in accordance to other non-RE MOFs. An alternative solution to the assumed μ₃-OH and/or μ₃-O groups is the possibility of bridging μ₃-F groups and there is some compelling crystallographic evidence to support this suggestion. Whether the bridging linkers are protonated or not, if μ₃-O is used instead of μ₃-F in the structural models, the thermal/displacement ellipsoids and the U_{eq} appear to be too small (i.e., smaller than the RE sites). Based on their respective coordination, the amount of electron density, and the absence of site disorder (either occupational or positional), it is logical for the RE sites to have less displacement. Refined models with μ₃-F bridges have both thermal/displacement ellipsoids and U_{eq} larger than the RE sites, this in agreement with comparative expectations. This may only be suggestive since one of the main limitations in single-crystal X-ray diffraction is the distinction of neighboring elements with similar atomic numbers. To validate the presence of μ₃-F sites in the structure, complementary analytical techniques were utilized that could distinguish between μ₃-0 and μ₃-F.

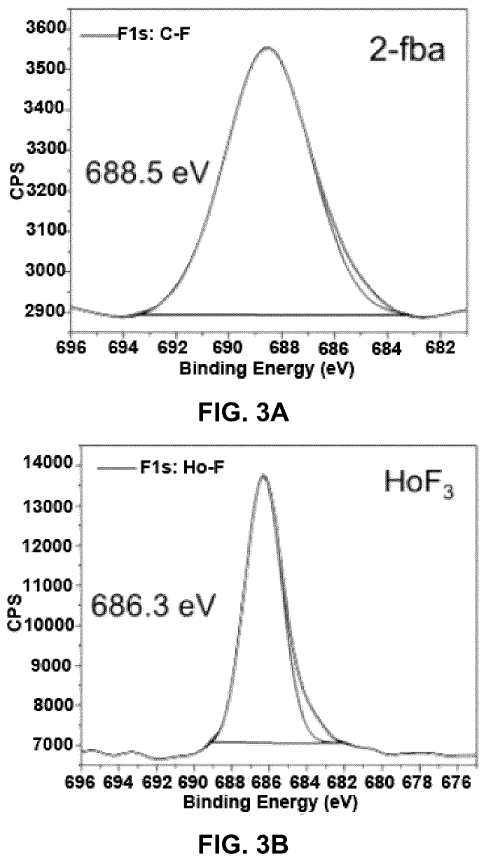

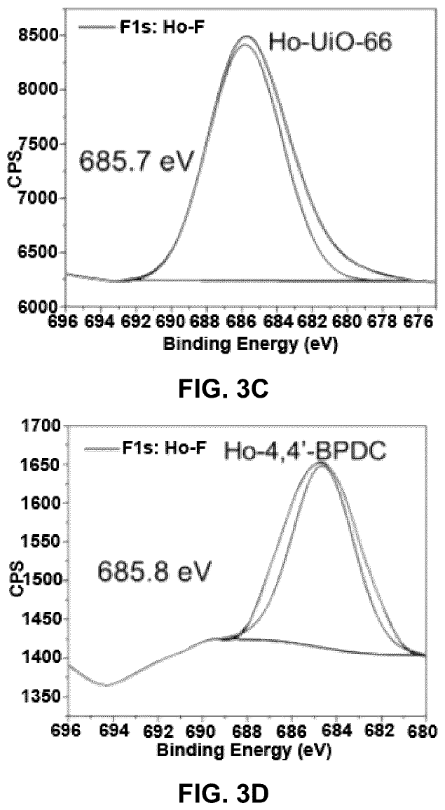

In particular, X-ray Photoelectron Spectroscopy (XPS) can be used in MOFs to elucidate the identities of the elements as well as their chemical states, e.g., their coordination environment. The XPS analysis for Ho-UiO-66 and Ho-4,4′-BPDC confirmed the presence of both holmium and fluorine in the MOFs. This was the case before and after activation under vacuum at 250° C., which is above the boiling point of 2-fba (245° C.). The observed fluorine 1s binding energies in the as synthesized samples were 685.7 eV for Ho-UiO-66 and 685.8 eV for Ho-4,4′-BPDC. In both cases, the binding energies were similar to HoF3 (686.3 eV) and lower than the binding energy of 2-fba (688.5 eV). A comparison is shown in FIGS. 3A-3D. XPS was also performed on a physical mixture of 2-fba and activated Ho-UiO-66 to highlight the different binding energies between the MOF and the 2-fba modulator. This proves that the observed fluorine signal does not correspond to trapped 2-fba in the pores of the MOF.

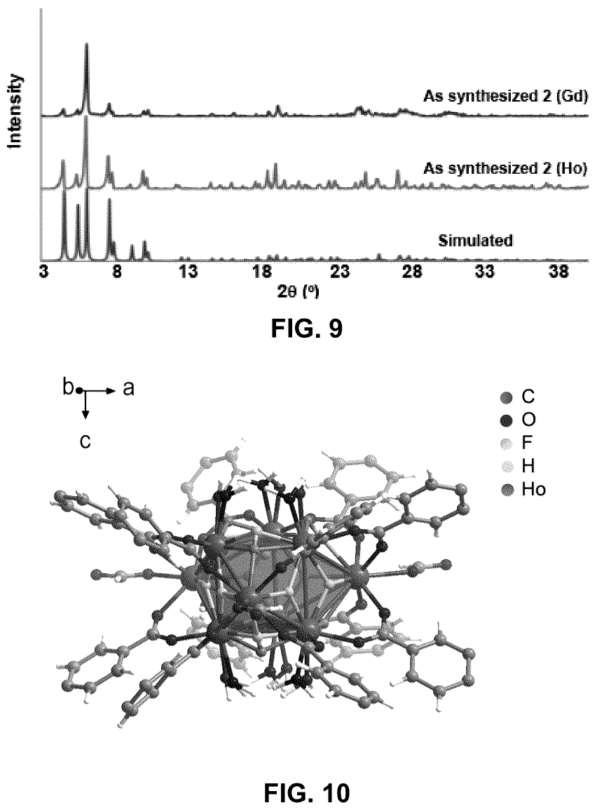

The MOFs oxygen 1s binding energies were also compared to Ho(OH)₃ (FIG. 9) to rule out the possibility of oxo/hydroxo bridging groups. Both Ho-MOFs showed two distinct peaks. The higher binding energy one corresponds to uncoordinated linker from defects (common for UiO-66) as well as solvent trapped in the pores. The presence of solvent was confirmed by TGA. The lower binding energy peak corresponds to the coordinated linker. None of these peaks have the observed binding energy of Ho—OH in Ho(OH)₃. Additionally, the oxygen XPS of Zr-UiO-66 was compared with the Ho-MOFs. In the case of the Zr MOF, a peak appears at lower binding energy that corresponds to the bridging oxygen in the cluster. This peak is not present in the Ho-MOFs.

To complement the XPS data, the FTIR spectra of both MOFs, Ho(OH)₃, HoF₃, and Zr-UiO-66 were collected and compared. In particular, Zr-based MOFs, such as UiO-66 or NU-1000, that have isostructural clusters show a well-defined band at 3675 cm⁻¹ corresponding to the bridging hydroxo groups. This signal is not present in the Ho-MOFs, further confirming the lack of these groups in the MOF.

Further evidence of fluorine presence in the MOFs was provided by SEM/EDS analysis. The Ho/F wt % ratio of the activated samples closely matches the calculated values from single crystal analysis. NMR was also used to discern the nature of the observed fluorine. The ¹H, ¹³C and ¹⁹F NMR for acid digested activated MOFs showed that no 2-fba is present inside the pores of these materials.

Interestingly, ¹⁹F NMR shows the presence of HF (δ=−169 ppm), which can be formed by dissolving HoF₃, or in the present case the fluoro-bridged cluster, in sulfuric acid. This signal was also observed by Xue et al. in 2013 on the Y-fcu MOF, but it was previously assigned to 2-fba. The ¹⁹F NMR of 2-fba has a signal at δ=−110 ppm.

The combination of all these results led to the conclusion that fluorine was indeed present as the bridging groups in these clusters, instead of the commonly assumed hydroxy groups. Thus, the source of the fluorine was further investigated.

Molecular complexes between REs and fluorocarbon groups have been studied as precursors for the activation of C—F bonds. With a comparable bond strength, RE-F bonds result in the weakening of the C—F bonds. C—F activation can lead to the formation of complexes, rings, cages, or clusters. In particular, C—F activation and fluorine extraction mediated by REs have been proposed to proceed through two different mechanisms: single electron transfer (SET) or by fluorine transfer and benzyne formation.

Reactions with 2,6-difluorobenzoic acid as the modulator also generated the Ho-UiO-66 and Ho-4,4′-BPDC MOFs. These results imply that the ortho-position site is an activating position and plays a role in the C—F activation mechanism. It was also observed that the use of excess modulator in the MOF solution results in HoF₃. Furthermore, the reaction of holmium with pure 2-fba or 2,6-dfba also results in HoF₃, proving that the fluorine in the modulator can be removed by holmium.

The confirmed presence of fluorine in the clusters, as well as 2-fba being the only source of fluorine, has major implications in the synthesis of RE MOFs using 2-fba. It is possible that most, if not all, MOFs that use fluorinated modulators to incorporate RE clusters in MOFs contain μ₃-F bridges in their structures. The work on these MOFs has been published in high impact journals, and while the presence of fluorine in no way discredits the results observed, a closer reexamination of these structures needs to be done. As an example, four RE MOFs were synthesized that use fluorinated modulators. After activation at 250° C., the presence of fluorine was confirmed by SEM/EDS. Without XPS analysis, this is not definite proof that fluorine is part of the cluster. Nevertheless, these highlight the need to revisit and analyze these structures in depth.

If the presence of fluorine is indeed confirmed in these RE MOFs, some of the observed properties could be attributed to the fluoro-bridged RE clusters. For example, in a recent report, a terbium hexacluster containing μ₃-F bridges was compared to the μ₃-OH-bridged analogue. The fluorinated compound had higher photoluminescence, a property reported in some of these MOFs. This would suggest that some of the MOFs with good photoluminescent properties could partially attribute them to the presence of μ₃-F groups. The presence of fluorine in the clusters could also explain some other properties, such as water stability, hydrophobicity, or CO₂ selectivities, common properties observed in fluorinated MOFs. In conclusion, it is reported for the first time the synthesis of MOFs containing fluoro-bridged RE clusters. Such clusters were previously reported only with μ₃-OH bridging groups, but the observed μ₃-F groups show a better crystallographic fit. The presence of fluorine in the clusters was confirmed by XPS, where the binding energies observed closely match the reported Ho—F bond energies. It is proposed that the source of the fluorine is likely the modulator, 2-fluorobenzoic acid, and the mechanism will be the subject of further investigation. While these are the first examples of fluoro-bridged clusters, it is believed that these are present in all RE MOFs that use 2-fba as a modulator. Other RE ions and linkers have been used with 2-fba, and in all cases fluoro-bridged clusters have been observed. If this is indeed the case, then some reported RE MOF crystal structures need to be revisited.

### Example 2: Solvent-Assisted Fluorine Extraction from 2-fba by RE Ions

### Results and Discussion

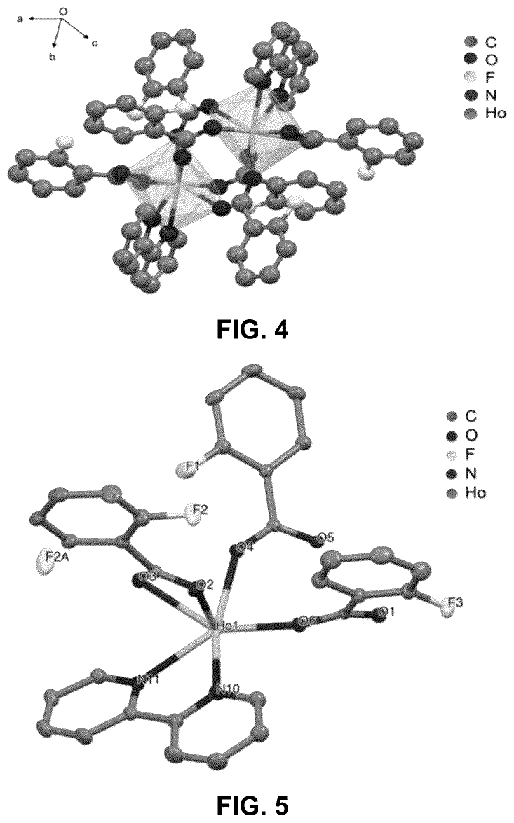

The solvothermal reaction between RECl₃·6H₂O (RE=Ho³⁺ and Gd³⁺) and the organic modulator, 2,2′-bipyridine (2,2′-bpy) and 2-fba resulted in crystals formulated by single-crystal X-ray diffraction as RE₂(C₇H₄FO₂)₆(C₁₀H₈N₂)₂(RE=Ho³⁺ and Gd³⁺) 1 (FIG. 4 and Scheme 1).

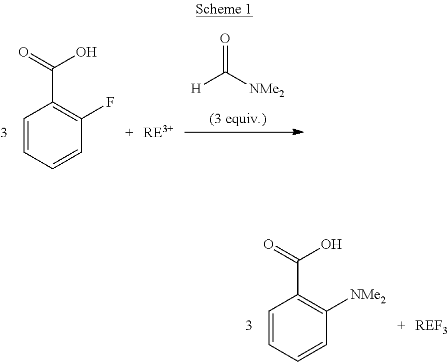 [SMILES: O=C(O)c1ccccc1F ; CN(C)C=O ; CN(C)c1ccccc1C(=O)O]

The phase purity of the bulk materials was confirmed by similarities between the simulated and as-synthesized powder X-ray diffraction (PXRD) patterns. As the dimeric complexes are isostructural, the Ho version is discussed in detail. Based on the recent report of fluorine extraction in the presence of RE metal ions and the formation of two different fluoro-bridged metal-organic frameworks, a fluoro-bridged cluster was expected. However, the H₂O solution resulted in the 2-fba molecules bound to the RE metal ions present in 1. Li et al also reported the formation of an isostructural RE-based complex where Sm³⁺ is bound to carboxylate group of 2-fba when ethanol was used as a solvent. Another RE-based complex where 2-fba is bound to the metal ions was reported by Guillerm et al. which resulted in a hexanuclear RE cluster (cuo-cluster). It is proposed that the first step in defluorination of 2-fba is when RE metal ions are bound to the carboxylate group of 2-fba. Thus, 1 can be considered a model for an intermediate in the synthesis of fluoro-bridged MOFs.

### Crystal Structure Description of 1 (Ho)

The Single-crystal X-ray diffraction (SCXRD) analysis of the Holmium complex revealed that 1 crystallized in a monoclinic crystal system with a P2_{1/n} space group and chemical formula of [C₆₂H₄₀F₆Ho₂N₄O₁₂]. Each Ho³⁺ metal ion is 8 coordinated in 1 and is bound to two oxygens of one bidentate 2-fba-ligand, four oxygens from four chelating bidentate ligands in a bridging coordination mode, and two nitrogens from a 2,2′-bpy ligand. In the asymmetric unit of 1, one Ho³⁺ ion, three 2-fba-ions and one 2,2′-bpy ligand are present. The two 2-fba-ions coordinated between the two Ho metal ions in a bridging mode are ordered, while the third 2-fba-ligand coordinated to only one Ho metal center in a bidentate chelating mode is disordered with two possible orientations having a percentage ratio of 87% and 13% in the average structure, as shown in the asymmetric unit (FIG. 5). It is worth noting that in this disordered 2-fba-, the phenyl plane is not coplanar to the carboxylate group, indicative of strong interactions between the fluoro group and the phenyl group in proximity. The two Ho³⁺ ions, related by a center of inversion (x, y, z<->1-x, 1-y, 1-z) in 1 have a coordination number of 8 and form a distorted square antiprism geometry. Each Ho³⁺ ion in 1 is connected with two oxygens (O2, O3) of one bidentate chelating 2-fba ligand, four oxygens (O1, O4, O5, O6) of four chelating bidentate ligands in a bridging coordination mode, and two nitrogens (N10, N11) of a 2,2′-bpy ligand. Atoms N10, N11, O2, O3, and O1, O5, O4i, O6i are the two formed squares of coordination environment geometry around the Ho metal center, with a torsional angle of 7.28 between each other.

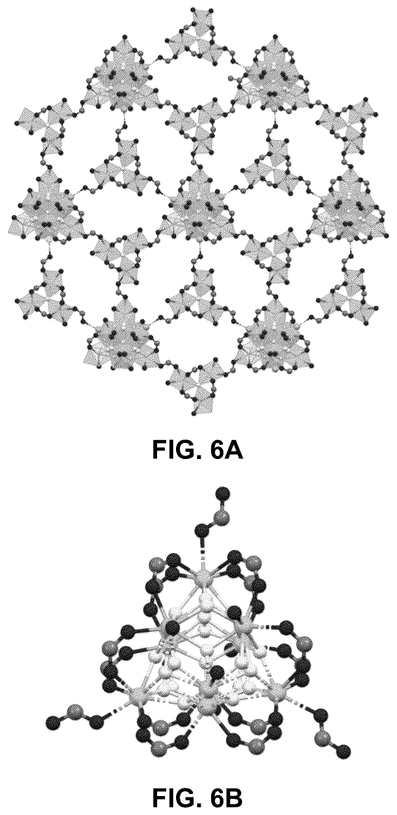

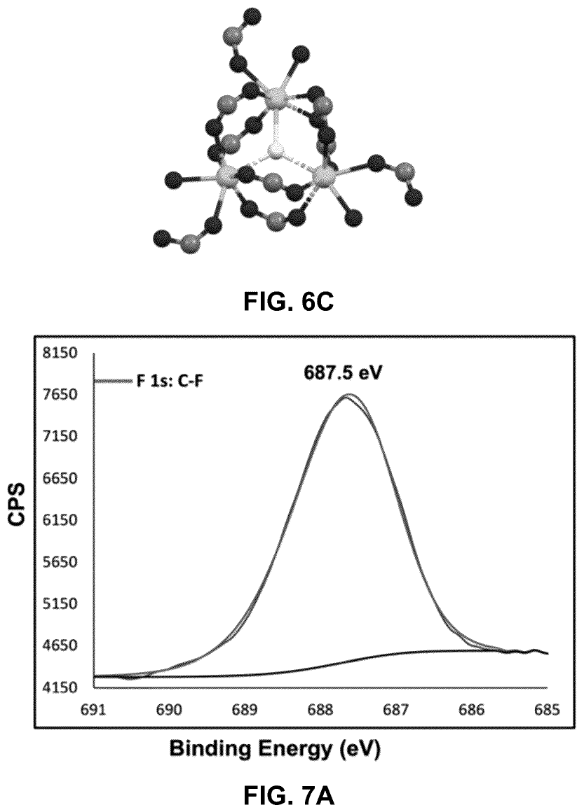

It was hypothesized that if 1 is a model for the first step in defluorination of the 2-fba; it may be possible to convert 1 into a fluoro-bridged MOF. As a test, 1 was reacted with the symmetrical triangular bridging ligand (H₃BTB) in DMF/HNO₃ solution at 120° C. This resulted in crystals of a fluoro-bridged RE-based 15-c nonanuclear and 9-c trinuclear cluster MOF formulated as {[RE₉(μ₃-F)₁₄(O₂C-)₁₂(H₂O)₆][RE₃(μ₃-F)(O₂C-)₆(H₂O)₃](HCO₂)₃(BTB)₆}-(solv)×2 (RE=Ho³⁺ and Gd³⁺). The fluoro-bridged structure of 2 is similar to JXNU-3 which was reported to have μ₃-O⁻ and μ₃-OH−-bridged clusters even though it was isolated using the cluster directing agent 2-fba. Based on the crystallographic data from the single-crystal X-ray diffraction analyses, 2 crystalized in the primitive hexagonal space group P62c and contains two distinctive 15-c nonanuclear clusters [RE₉(μ₃-F)₁₄(O₂C-)₁₂(HCO₂)₃(H₂O)₆] and 9-c trinuclear clusters [RE₃(μ₃-F)(O₂C-)₁₂(HCO₂)₃(H₂O)₃] which are connected by formate ligands from the decomposition of DMF molecules during the solvothermal synthesis. Since both MOFs are isostructural, the Ho version of 2 is addressed in detail (FIGS. 6A-6C). The phase purity of bulk material was proven by similarities between the simulated and as-synthesized powder X-ray diffraction (PXRD) patterns (FIG. 8).

### Crystal Structure Description of 2 (Ho)

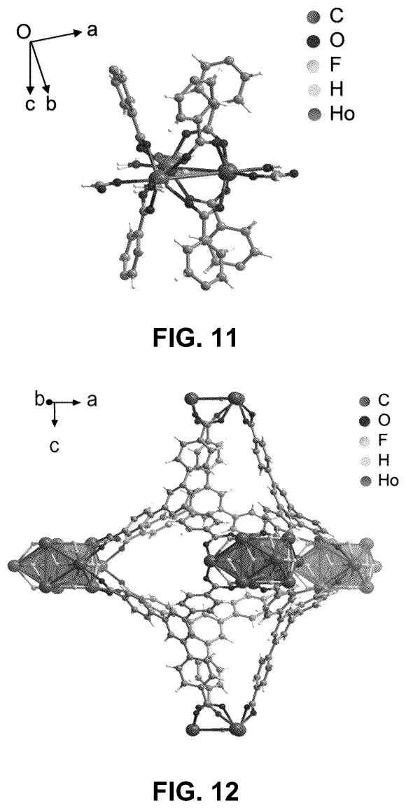

In the crystal structure of 2, the 15-c nonanuclear (FIG. 9) clusters form triaugmented triangular prisms with the Ho atoms at the vertices. The upper and lower rim of the prism consist of 6 Ho atoms that are coordinated with 7 ligands, 3μ₃-F⁻ ions, 2 carboxylate groups, a water molecule and two disordered bridging F ions. The disordered F⁻ ions were found to coexist in two coordination modes, μ₃- or μ₂-bridging modes. Moreover, the position disordering of the F⁻ ion leads to the positional disordering of the water molecule due to rearrangement of the coordination sphere. The other 3 Ho atoms are located at the center rim of the prism and were coordinated by 9 ligands, a formate ion, 4 carboxylate groups and 5 bridging F⁻ ions. Although related 15-c nonanuclear clusters have been reported in RE-based MOFs, the fluoro-bridging is unprecedented. The 9-c trinuclear (FIG. 10) cluster adapts an equilateral triangular configuration with a μ₃-F⁻ ion at the center of the triangle. Each Ho atoms in the trinuclear cluster are coordinated to 7 ligands, 4 bridging carboxylate groups located at two sides of the triangular plane, a water molecule, a formate ion, and a μ₃-F⁻ ion. In the 3D structure of 2, the BTB³⁻ ligands adopt a nonplanar “propeller” shaped configuration and forms triangular bipyramidal pores (FIG. 11) with 3 nonanuclear clusters at the equatorial vertices and 2 trinuclear clusters at the axial vertices. Each of the triangular bipyramidal pores consist of 6 BTB³⁻ ligands as the panels and have an axial dimension of 2.8 nm along c axis. Each of the 9-c trinuclear clusters are connected to 2 different triangular bipyramidal pores by the axial vertices along c axis and 3 adjacent nonanuclear cluster by bridging formate ions, while each 15-c nonanuclear cluster in the structure connects to 3 different triangular bipyramidal pores in the ab plane, forming a honeycomb-like layer. Interestingly, without bridging formate ions in the structure, 2 would have been a two-fold interpenetrated framework. The existence of these formate bridges leads to the formation of a rare trinodal (3,9,15)-connected net that was only found previously in JXNU-3. Not only does the decomposition of DMF result in formate molecules, but it results in dimethylamine (DMA) which is postulated to be involved in the defluorination of fluorinated modulators. To support the hypothesis of DMA involvement in defluorination, 1 (Ho) was reacted with DMA in water and it resulted in HoF₃ and some layered holmium hydroxide due to increase in pH (FIG. 12).

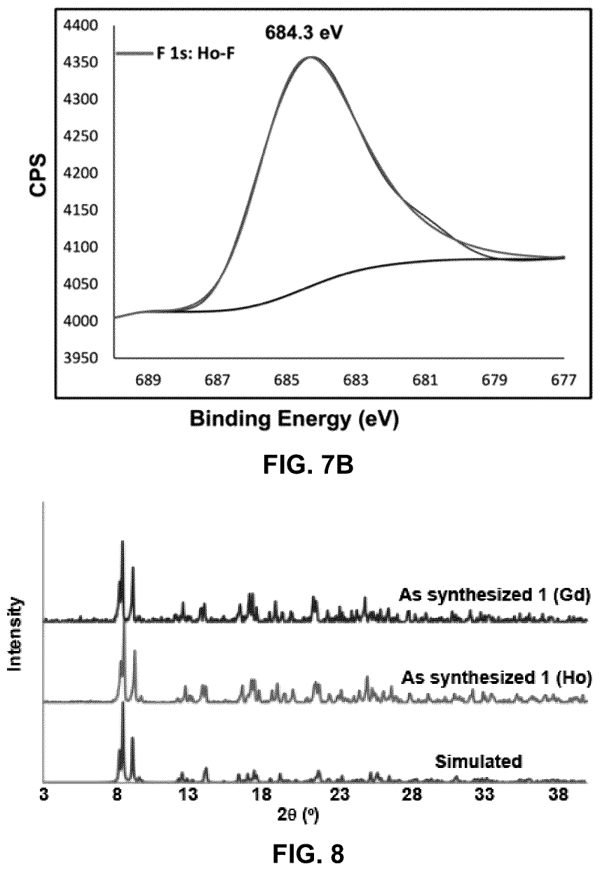

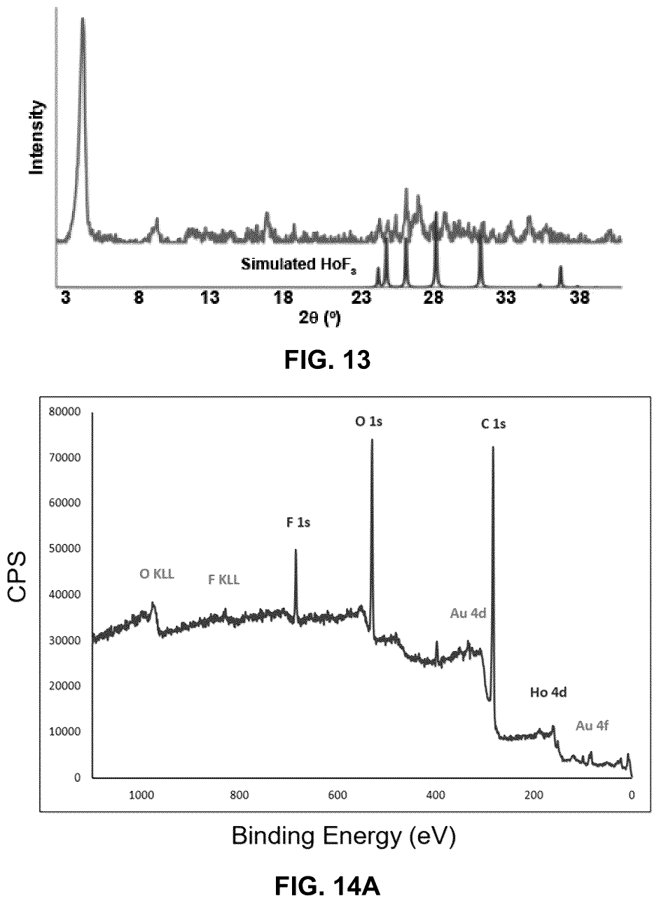

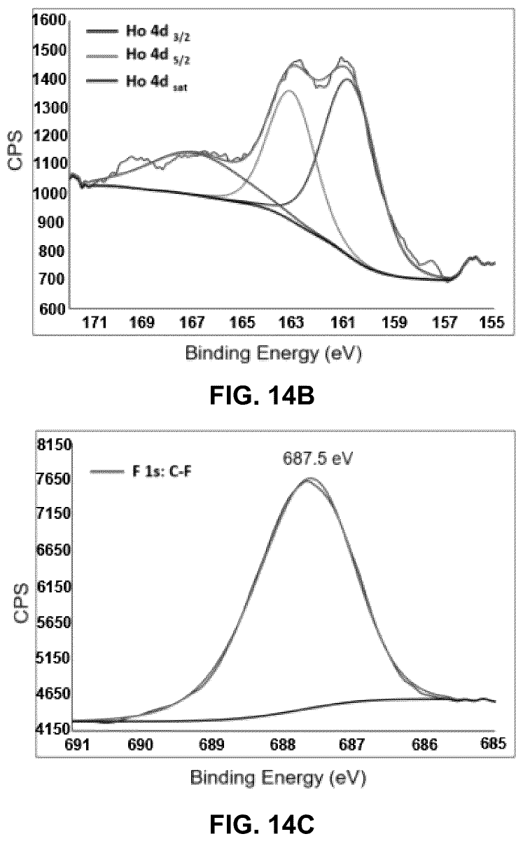

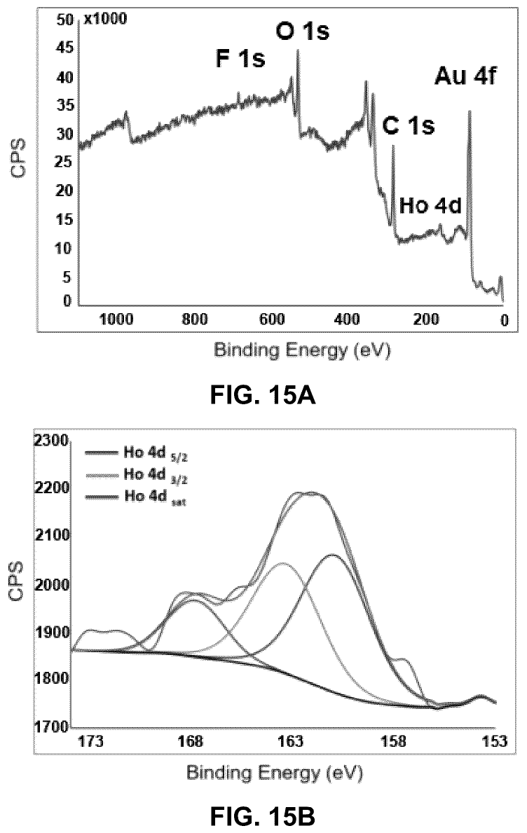

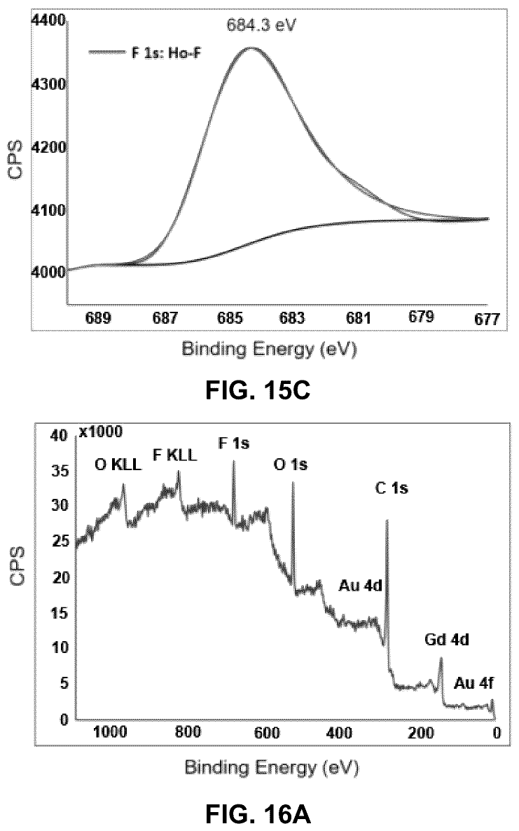

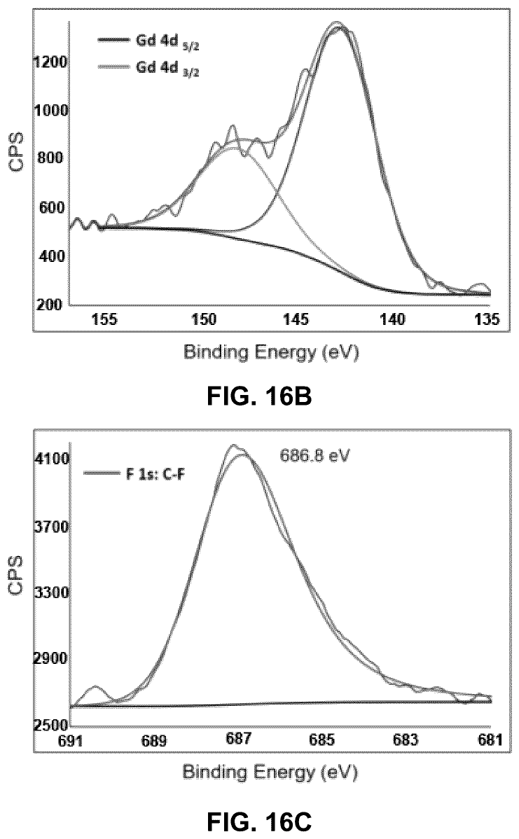

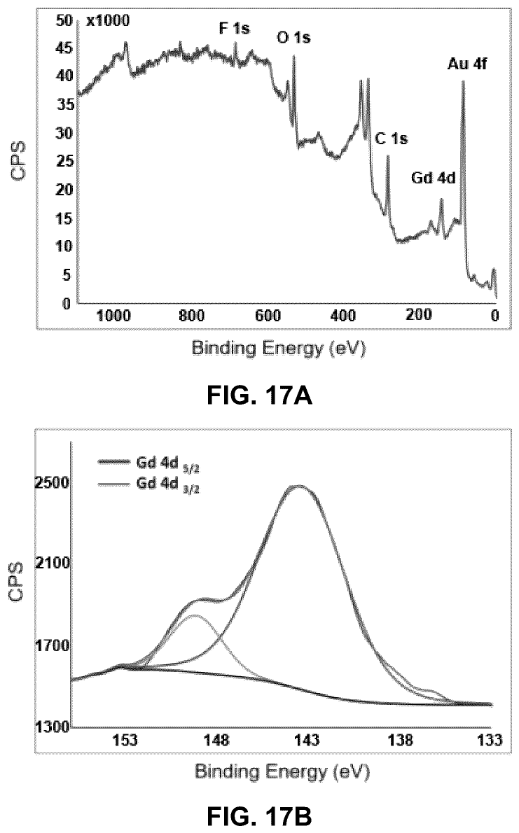

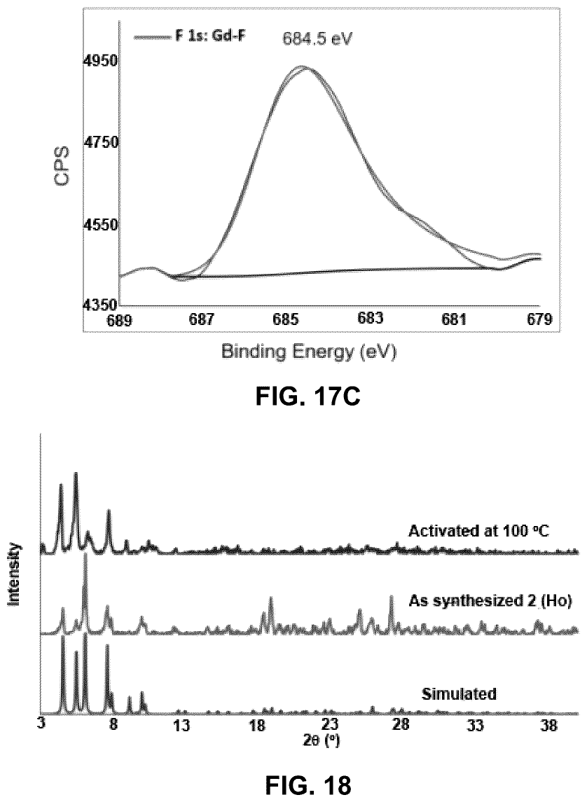

In order to confirm the presence of fluorine bridges in 2, complementary analytical techniques that differentiate between μ₃-F⁻ and μ₃-O⁻ were performed. X-ray photoelectron spectroscopy (XPS) was utilized to measure the elemental composition as well as chemical states of the elements based on the electron-binding energies. The XPS analyses for 1 and 2 confirmed the presence of holmium and fluorine in these structures (FIGS. 13-14C). The XPS data for the isostructural structures of 1 (Gd) and 2 (Gd) are also presented (FIGS. 16A-17C). 2 was activated at 250° C. under vacuum for 24 h to remove any 2-fba trapped in the pores (boiling point of 2-fba is 245° C.). The fluorine 1s binding energy for 1 (Ho) was 687.5 eV for the bound 2-fba which is similar to the bulk 2-fba (688.5 eV).30 In contrast, the binding energy of fluorine 1s for μ₃-F in 2 (Ho) was 684.3 eV which is similar to HoF₃ (686.3 eV) and lower than the binding energy of free 2-fba (688.5 eV). FIGS. 7A-7B show the comparison of the binding energy of fluorine 1s for 1 (Ho), and 2 (Ho) obtained from the 1.

To further confirm the presence of fluorine in 2 obtained from 1, SEM/EDS analyses were performed (Tables 2 and 4). The average Ho:F wt. % ratio of the activated 2 (Ho) is 7.2±0.2 close to the theoretical wt. % ratio of 7 determined from the single crystal analysis data.

TABLE 2
EDS Data for Activated 2 Ho) Obtained from 1 (Ho)

| Compound 2 (Ho) | Average Wt % |
|---|---|
| C | 35.13 |
| O | 14.94 |
| F | 6.08 |
| Ho | 43.83 |
| Total | 100 |

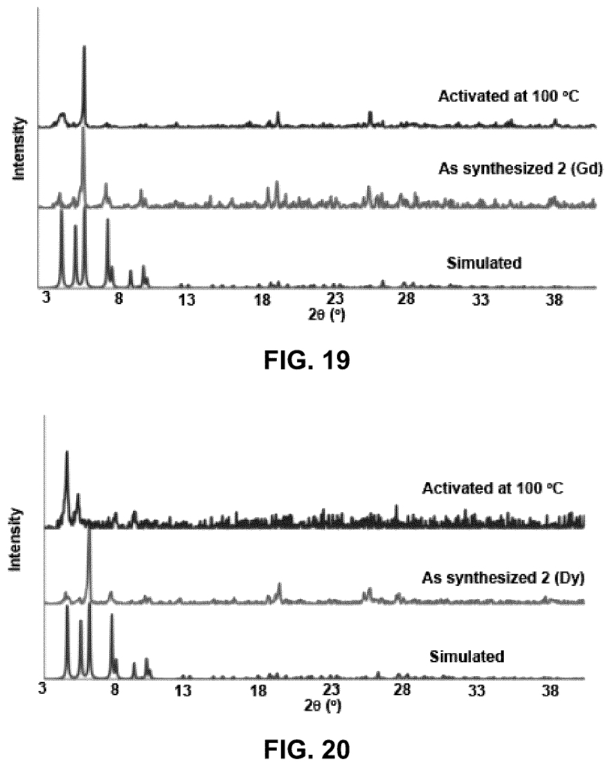

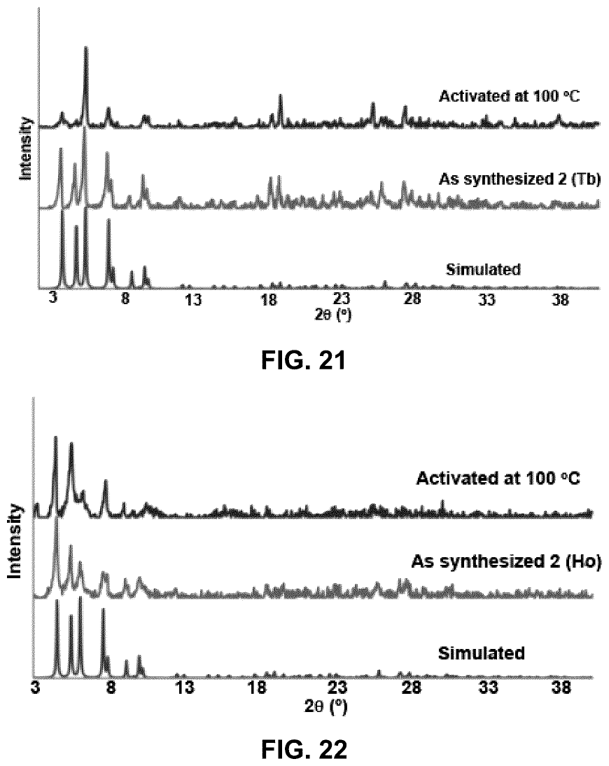

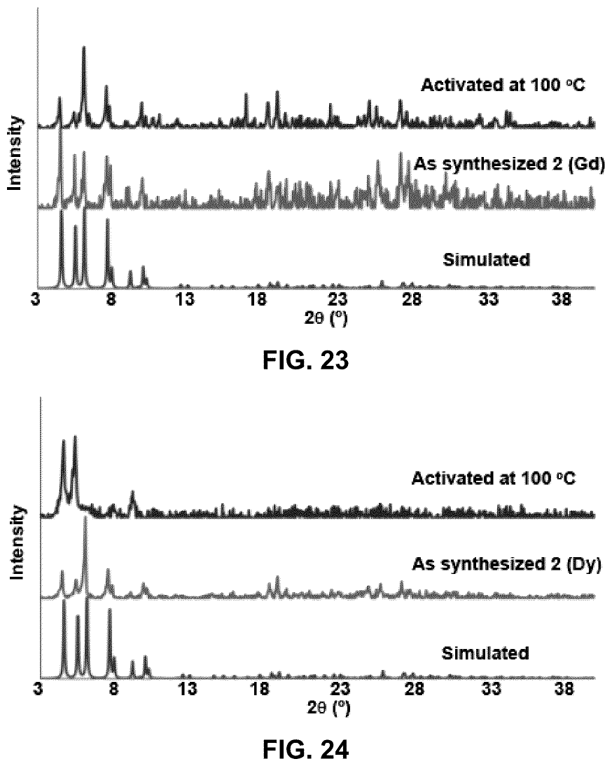

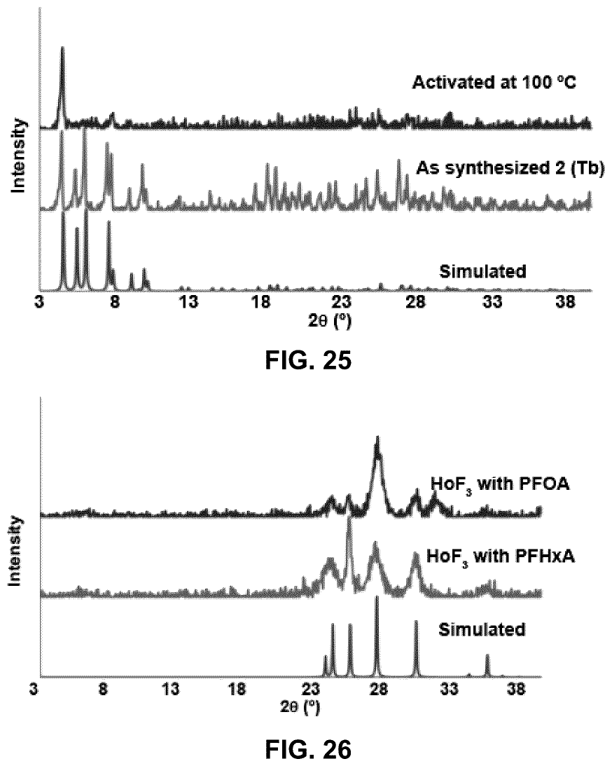

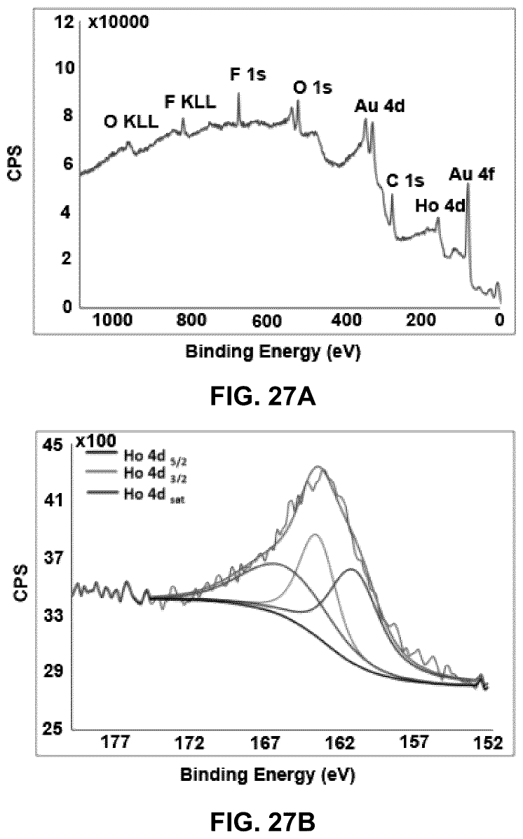

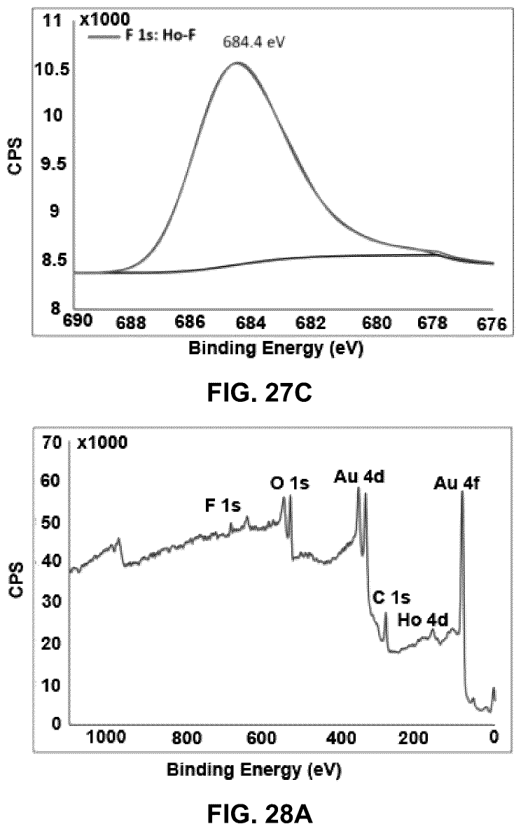

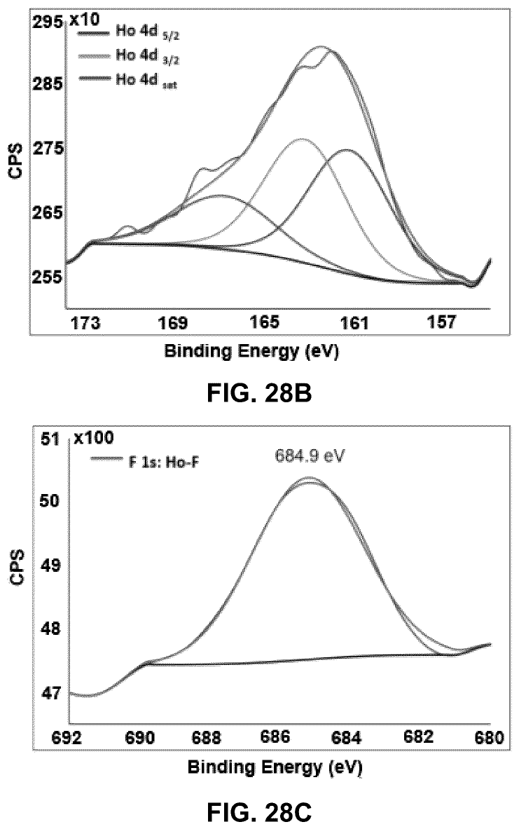

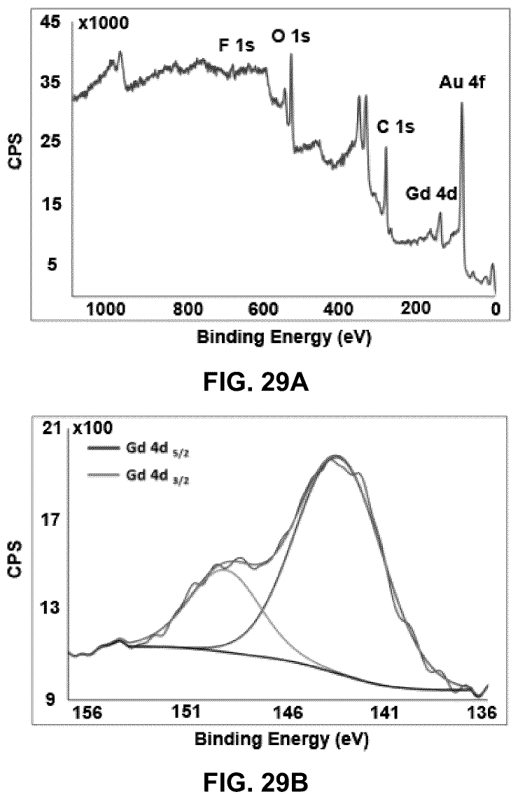

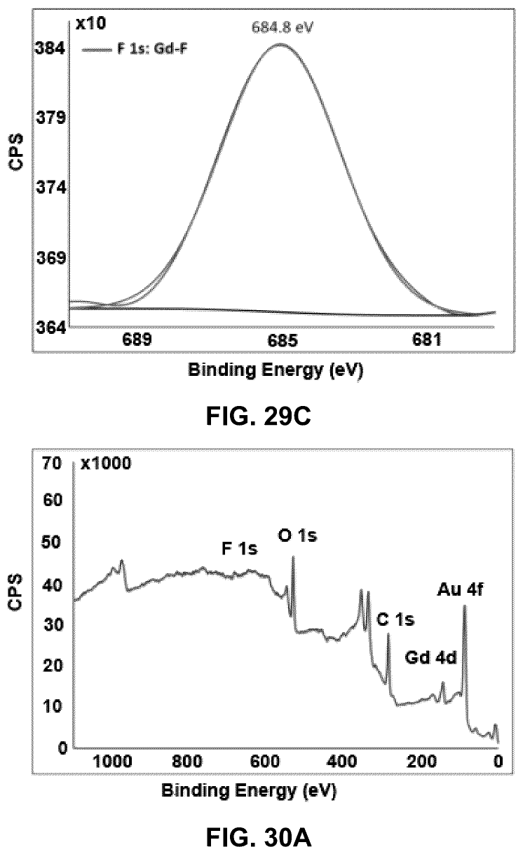

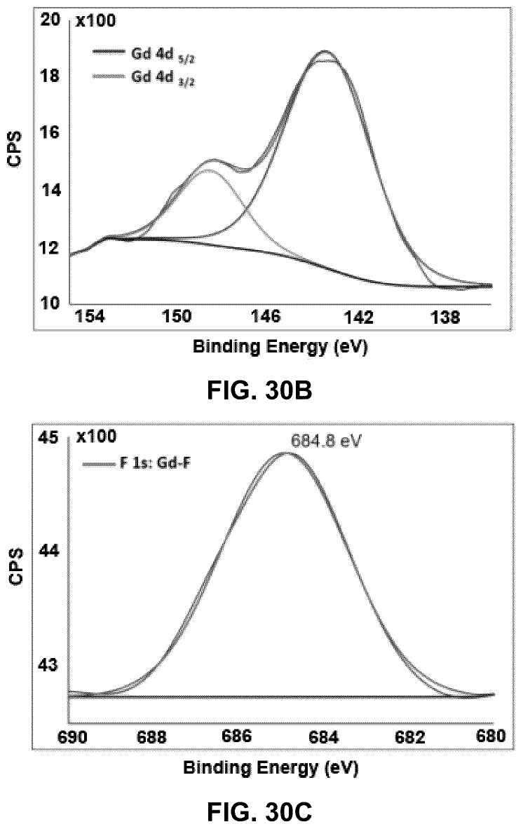

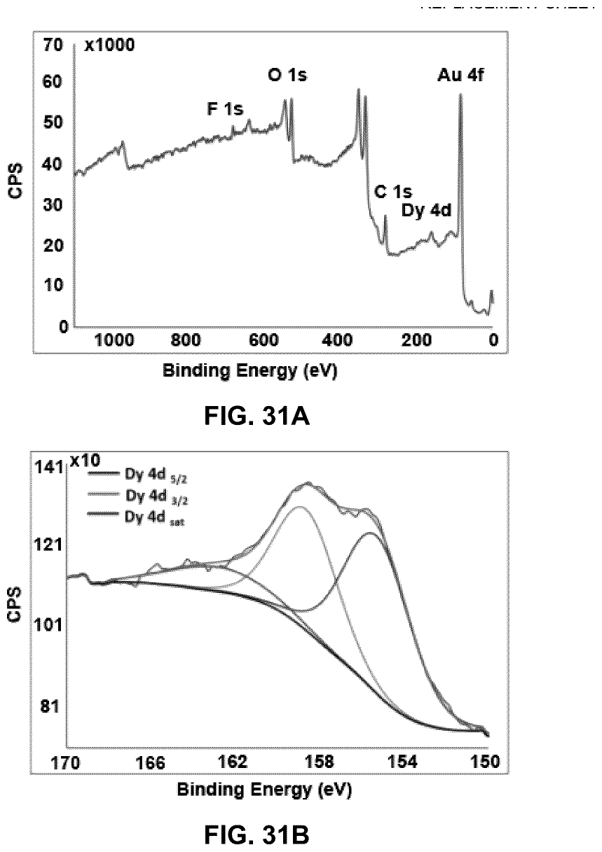

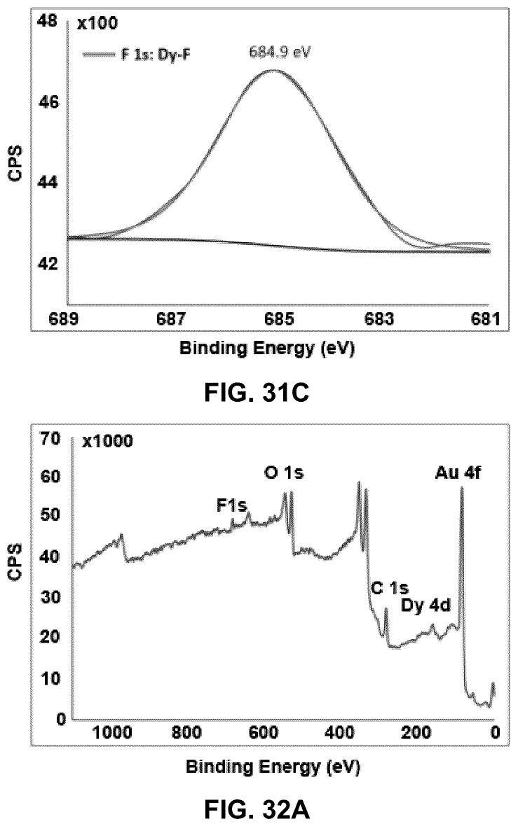

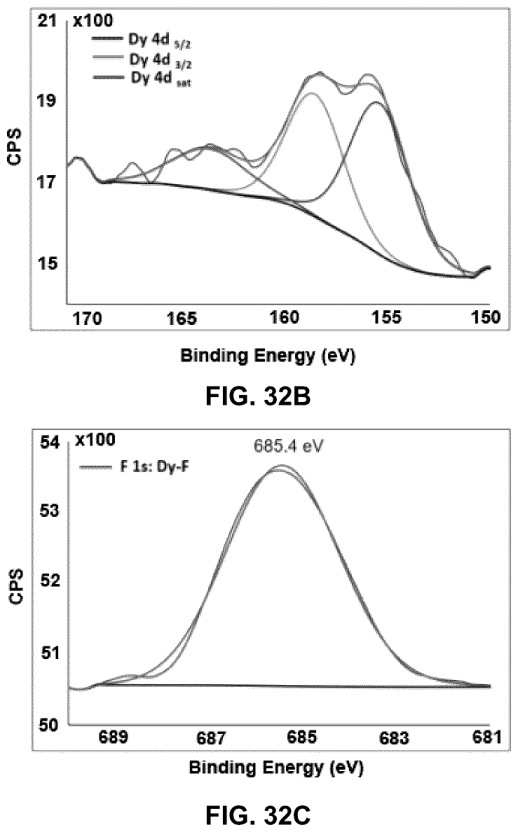

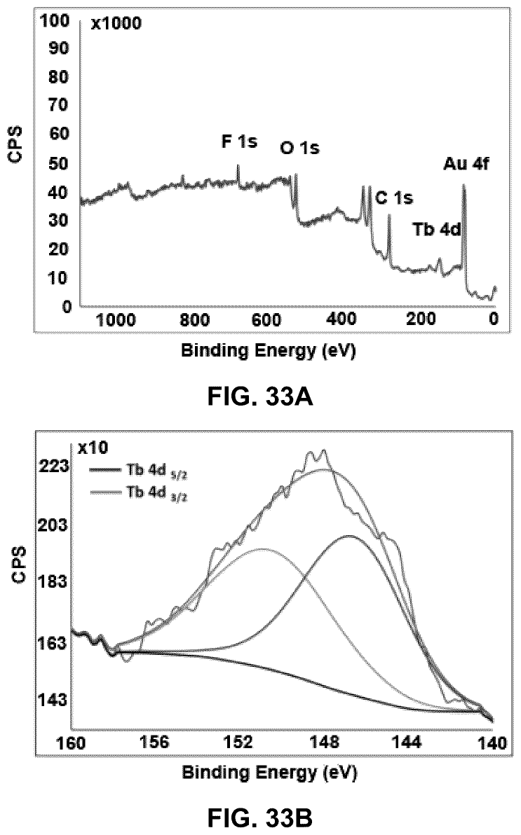

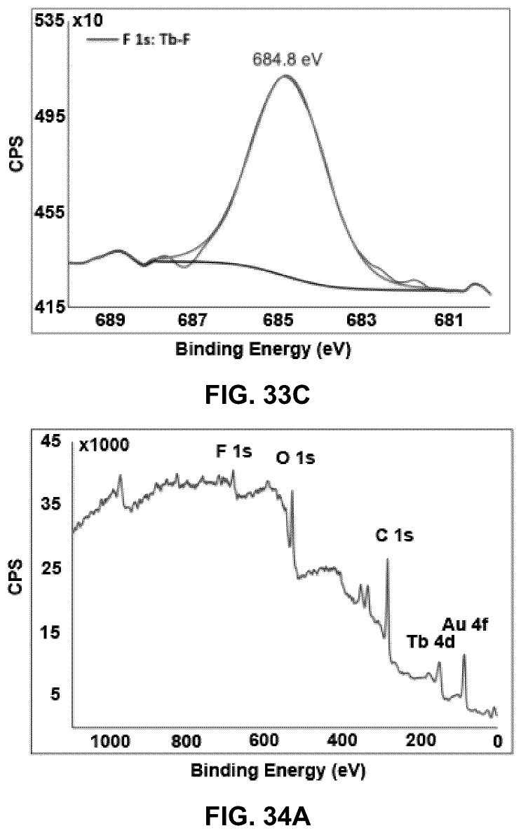

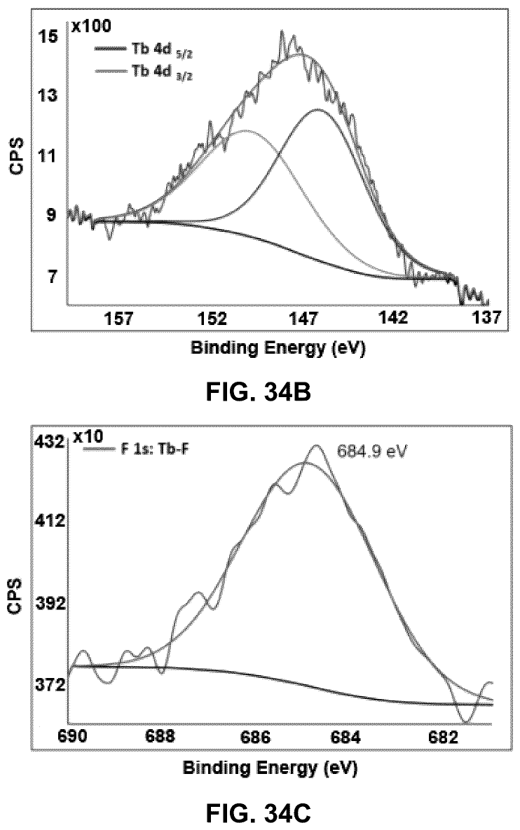

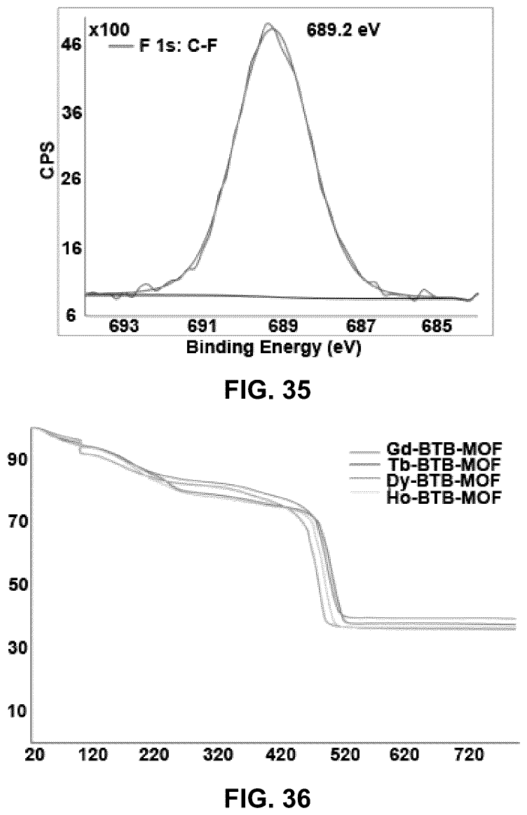

Since a modulator competes with the linker for coordination to the metal ions, it was hypothesized that changing the donor strength (pKa) may affect the reaction. (pKa of 2-fba 3.27; pKa of H3BTB 3.46; pKa of PFHxA>>-0.1). As part of an investigation of defluorination of organofluorine modulators, per- and polyfluoroalkyl substances (PFAS) were tested. The solvothermal reactions between RE(NO₃)₃·xH₂O (RE=Ho³⁺, Gd³⁺, Dy³⁺, and Tb³⁺) and 1,3,5-tri(4-carboxyphenyl)benzene (H3BTB) in a N,N′-dimethylformamide (DMF)/water/HNO₃ solution were carried out in the presence of two modulators, perfluorohexanoic acid (PFHxA) or perfluorooctanoic acid (PFOA). This resulted in hexagonal shaped crystals of 15-c nonanuclear and 9-c trinuclear cluster MOFs 2 (FIGS. 6A-6C). The phase purity of bulk material was proven by similarities between the simulated and as-synthesized powder X-ray diffraction (PXRD) patterns (FIGS. 17A-24). However, when heat is applied to 2 (Dy) and 2 (Tb), some structural changes are observed (FIGS. 19-20 and 23-24). The reaction of holmium with pure PFHxA or PFOA resulted in HoF₃, showing that the fluorine in these modulators can be extracted by holmium (FIG. 25). The XPS analyses of 2 (RE=Ho³⁺, Gd³⁺, Dy³⁺, and Tb³⁺) confirmed the presence of fluorine in these structures (FIGS. 26 and 33A-33C). The fluorine 1 s binding energy for PFHxA was 689.2 eV (FIGS. 34A-34C). 2 (RE=Ho³, Gd³⁺, Dy³⁺, and Tb³⁺) were activated at 200° C. under vacuum for 24 h to remove any trapped PFHxA or PFOA in the pores (boiling point of PFHxA is 157° C. and PFOA is 189° C.). The TGA and PXRD of 2 with PFHxA and PFOA as modulators activated at 200° C. confirmed that MOF survived the activation temperature.

Furthermore, EDS analyses of activated 2 (RE=Ho³⁺ and Gd³⁺) with PFHxA and PFOA as modulators confirmed that fluorine is present in these structures and the average RE:F wt % ratio of the activated samples closely matches that calculated from the single-crystal data.

Fluorine nuclear magnetic resonance (¹⁹F-NMR) spectroscopy was used to further confirm the presence of fluorine in the MOFs. The ¹⁹F-NMR spectra of acid-digested MOFs show that there were no trapped 2-FBA, PFHxA, or PFOA in the pores. The observed peak with a chemical shift at −169 ppm corresponds to HF formed from the fluorine bridges in the digested MOF.

In order to compare the effect of fluorinated modulators on the extent of metal cluster fluorination, JXNU-3 (Gd) was made following the published procedure using 2-FBA as a modulator in an autoclave for 6 days at 120° C. JXNU-3 (Gd) was reported to be a charged framework with oxo bridges and protonated dimethylamine cations in the pores balancing the charge. In contrast, the SCXRD of 2 (Ho) shows only three DMF molecules in the pores, which is consistent with structure 2 being a non-charged framework. To confirm the presence of DMF in 2 (Gd) with PFHxA as modulator, the FT-IR spectra of both MOFs were collected and compared. JXNU-3 (Ho) was also synthesized, and its FT-IR was collected and compared to 2 (Ho) with PFHxA as modulator. MOF 2 shows a peak assigned to DMF at 1660-1670 cm⁻¹, while this peak is missing for JXNU-3. The XPS survey spectra of JXNU-3 prepared in the study shows that there is some M-F present. Interestingly, the O 1s spectrum also shows a significant amount of Gd—O(H)—Gd compared to a small amount of Gd—O(H)—Gd present in 2 (Gd) with PFHxA as modulator. The O 1s spectrum of 2 (Ho) with PFHxA as modulator shows that there may be only a small amount of M-O(H)-M compared to JXNU-3 (Ho). It is proposed that the synthesis conditions including time, temperature, pressure, and solvent as well as the use of 2-FBA may give rise to M-F-M or M-O(H)-M bridges or mixtures. This is not surprising because it has been reported that both F and O(H) bridges can form in a rare-earth MOF by solid-state NMR. The nature of the organofluorine is important, where the PFAS are better than the 2-FBA at forming F-bridged clusters. This may be explained by the weaker aliphatic C—F bond versus the aromatic C—F bond. Additionally, there are more fluorines per molecule with the PFAS that can be extracted. The PFAS gives rise to >96% F in the structure. It is actually a challenge to increase the percentage of the oxy-/hydroxy-bridged rare-earth clusters in the presence of 2-FBA or PFAS.

It has been reported that hydrogen peroxide can act as a p-hydroxo bridge promoter in the synthesis of terephthalate-based MOF. Therefore, hydrogen peroxide was added to the synthesis of 2 (Ho) when PFHxA was used as modulator. Interestingly, the XPS spectra of the resulting MOF showed no fluorine bridges only of M-O(H)-M. Thermo-gravimetric analyses of the fluorinated and oxo-bridged MOFs were collected. The fluorinated MOF of 2 (Ho) with PFHxA as modulator is more stable than the oxo-bridged one, 2 (Ho) with H₂O₂. This was predicted by Christian et al., where the fluorinated clusters were calculated to be thermodynamically more stable than hydroxylated clusters by up to 8-16 kJ/mol per atom for 100% fluorination. The extraction of fluorine from PFHxA by RE ions is potentially an important discovery in the remediation of these organic pollutants. Furthermore, SEM/EDS analyses of activated 2 (RE=Ho³⁺, Gd³⁺, Dy³⁺, and Tb³⁺) confirmed that fluorine is present in these structures and the average RE:F wt. % ratio of the activated samples closely matches to the calculated from the single crystal analyses data (Tables 5-12). The extraction of fluorine from PFHxA by RE ions is potentially an important discovery in the remediation of these persistent organic pollutants.

### Experimental Section

Reagents and Chemicals. All chemicals and solvents were used as purchased without further purification. Gadolinium (III) chloride hexahydrate (99.9%) and sulfuric acid-D₂ (96% solution in D₂O) were purchased from Sigma-Aldrich (St. Louis, MO, USA). Holmium (III) chloride hexahydrate (99.9%), Holmium (III) nitrate pentahydrate (99.9%) and Perfluorooctanoic acid (95.0%) were purchased from Strem Chemicals, Inc (Newburyport, MA, USA). Dysprosium (III) nitrate pentahydrate (99.9%) was purchased from Alfa Aesar (Ward Hill, MA, USA). 2-fluorobenzoic acid, 1,3,5-tri(4-carboxyphenyl)benzene (97%) and perfluorohexanoic acid were purchased form TCI America, inc. (Portland, OR, USA). Gadolinium (III) nitrate hexahydrate (99.9%), Terbium (III) nitrate pentahydrate (99.9%), 2,2′-bipyridine (99+%), N,N′-dimethylformamide (DMF), acetic acid, glacial (certified ACS), concentrated nitric acid, Deuterium oxide, for NMR, (99.8 atom % D) and methyl sulfoxide-d₆, for NMR, (99.5+ atom % D) were purchased from Thermo Fisher Scientific (Waltham, MA, USA).

Instrumental Methods. The single-crystal X-ray diffraction measurements for 1 (Ho) were carried out at (110 K) employing a three circle Bruker-AXS Quest diffractometer (IμS Mo Kα radiation, λ=0.71073 Å) and a Kappa Bruker-AXS Venture (IμS Cu Kα radiation, λ=1.54178 Å) for 2 (Ho). The powder X-ray diffraction (PXRD) measurements were performed on an Ultima IV X-ray diffractometer (Rigaku) at 45 kV, 40 mA using Cu Kα radiation with a scan speed of 2°/min and a step size of 0.04°. The thermal gravimetric analyses (TGA) were performed under a continuous nitrogen flow using a TA Instrument SDT Q600 thermal gravimetric analyzer (New Castle, DE, USA) with a heating rate of 10° C./min. The materials were heated to 100° C. and held for 10 minutes to remove water and then heated to 800 with a rate of 10° C./min. The scanning electron microscopy (SEM) energy-dispersive X-ray spectroscopy (EDS) was performed on a Zeiss EVO LS SEM and Aztec Instruments Oxford EDS. The X-ray photoelectron spectroscopy (XPS) data was collected on PHI VersaProbe II Scanning XPS Microprobe (Physical Electronics Inc, Chanhassen, Minnesota) equipped with (Al Kα radiation, Ep=1486.7 eV) at pressure 1.6×10⁻⁹ Torr. The high-resolution spectra were collected at the pass energy of 29.35 eV with a step size of 0.12 eV. Photoelectron spectra were obtained using a charge compensation of 2 mA. The data was processed with software CasaXPS and energies were calibrated to adventitious C1 s at 284.8 eV.

Synthesis of 1 (RE=Ho³⁺ and Gd³⁺). A solution of HoCl₃·6H₂O (265.6 mg, 0.7 mmol) or GdCl₃·6H₂O (225.7 mg, 0.5 mmol), 2,2′-bipyridine (156 mg, 1 mmol), 2-fluorobenzoic acid (100 mg, 0.7 mmol) in deionized water (35 mL) was prepared in a round-bottom flask while the pH of the solution was controlled in a range of 5-6 with 2 M NaOH and then reacted at 120° C. for 24 h while stirring. The crystalline product was collected and washed with deionized water for 3 times, and dried at 80° C. overnight.

Transformation of 1 to 2 (RE=Ho³⁺ and Gd³⁺). A solution of 1 (25.7 mg), 1,3,5-tri(4-carboxyphenyl)benzene (15.4 mg, 0.035 mmol) in N,N′-dimethylformamide (DMF) (11.0 mL), H₂O (2.5 mL), HNO₃ (0.20 mL) and acetic acid (80 μL), was prepared in a 20 mL scintillation vial and subsequently heated to 120° C. for 24 h. The crystalline product was collected and washed with DMF 3 times, and dried at 80° C. overnight.

Synthesis of HoF₃ with PFHxa or PFOA. Ho(NO₃)₃·5H₂O (97.02 mg, 0.22 mmol) and perfluorohexanoic acid (310 μL, 1.74 mmol) or perfluorooctanoic acid (500.0 mg, 1.20 mmol) were dissolved in DMF (11.0 mL) in a 20 mL scintillation vial, the solution was heated at 120° C. for 24 h. The resulting white powder was cooled to room temperature and washed with DMF 3 times, and dried at 80° C. overnight.

Synthesis of 2 with PFHxA or PFOA (Re=Ho³⁺, Gd³⁺, Dy³⁺, and Tb³⁺). A solution of Ho(NO₃)₃·5H₂O (97.02 mg, 0.22 mmol), or Gd(NO₃)₃·6H₂O (99.30 mg, 0.22 mmol), or Dy(NO₃)₃·5H₂O (96.50 mg, 0.22 mmol), or Tb(NO₃)₃·5H₂O (95.70 mg, 0.22 mmol) was coordinated with 1,3,5-tri(4-carboxyphenyl)benzene (44.0 mg, 0.10 mmol) and perfluorohexanoic acid (310 μL, 1.74 mmol) or perfluorooctanoic acid (500.0 mg, 1.20 mmol) in N,N′-dimethylformamide (DMF) (11.0 mL), H₂O (2.50 mL), HNO₃ (0.20 mL) and acetic acid (80 μL), was prepared in a 20 mL scintillation vial and subsequently heated to 120° C. for 24 h. The crystalline product was collected and washed with DMF 3 times, and dried at 80° C. overnight.

Transformation of 1 to HoF₃ in the presence of DMA. Compound 1 (110 mg) in presence of dimethylamine (400 μL) was reacted in water (11 mL) while heating to 120° C. for 24 h. The resulting white powder was collected and washed with water and dried at 80° C. overnight.

Synthesis of 2 (Ho) with H₂O₂. A solution of Ho(NO₃)₃·5H₂O (97.02 mg, 0.22 mmol) was coordinated with 1,3,5-tris(4-carboxyphenyl)benzene (44.0 mg, 0.10 mmol), perfluorohexanoic acid (310 μL, 1.74 mmol), and hydrogen peroxide (21 μL, 0.22 mmol) in N,N′-dimethylformamide (DMF) (11.0 mL), H₂O (2.50 mL), HNO₃ (0.20 mL), and acetic acid (80 μL), prepared in a 20 mL scintillation vial, and subsequently heated to 120° C. for 24 h. The crystalline product was collected and washed with DMF three times and dried at 80° C. overnight.

Experimental details for SCXRD. The single crystal X-ray diffraction measurements of the single crystal X-ray diffraction datasets were carried out at 110 K employing a three circle Bruker-AXS Quest IαS Mo source for compound 1 (Ho) and a kappa Bruker-AXS Venture IαS Cu source for compound 2 (Ho). A Photon III area detector was used in both diffractometers (NSF-CHE-9807975, NSF-CHE-0079822 and NSF-CHE-0215838). In a typical measurement, a crystal was mounted on a Kapton® loop and cooled in a cold nitrogen stream (OXFORD Cryosystems), to 110(2) K. Bruker AXS APEX 3 software was used for data collection and reduction. Absorption corrections were applied using SADABS. Space group assignments were determined by examination of systematic absences, E-statistics, and successive refinement of the structures. Structures were solved using SHELXT and refined by least-squares refinement on F² followed by difference Fourier synthesis in the OLEX2 interface with the SHELXL program. All hydrogen atoms were included in the final structure factor calculation at idealized positions and were allowed to ride on the neighboring atoms with relative isotropic displacement coefficients. Thermal parameters were refined anisotropically for all non-hydrogen atoms to convergence. Platon Squeeze⁶ integrated into OLEX2 interface was used to model disordered solvent molecules in the Structures. Crystal data and refinement conditions are shown in Table 3.

TABLE 3
Crystallographic Data for Compound 1 (Ho) and Compound 2 (Ho)

| Compound | 1 | 2 |
|---|---|---|
| CCDC | 2204645 | 2204646 |
| Chemical formula | C₆₂H₄₀F₆Ho₂N₄O₁₂ | C₁₇₄H₁₃₂F₁₅Ho₁₂N₃O₅₄ |
| Temperature/K | 110 | 110 |
| Crystal system | Monoclinic | Hexagonal |
| Space group | P2₁/n | P6̅2c |
| a (Å) | 12.0621(9) | 22.2817(3) |
| b (Å) | 17.669(1) | 22.2817(3) |
| c (Å) | 13.455(1) | 28.9395(8) |
| α (°) | 90 | 90 |
| β (°) | 112.025(2) | 90 |
| γ (°) | 90 | 120 |
| V (Å³) | 2658.4(4) | 12442.8(5) |
| Z | 2 | 2 |
| Radiation type | Mo Kα (λ = 0.71073 Å) | Cu Kα (λ = 1.54178 Å) |
| θ range (°) | 3.874 to 66.364 | 4.58 to 149.65 |
| Reflections | 84337 | 170101 |
| collected | | |
| Independence | 10148 | 8725 |
| reflection | | |
| Rᵢₙₜ | 0.0663 | 0.0982 |
| Goodness-of-fit | 1.088 | 1.046 |
| (GOF) on F² | | |
| Final R indices | R₁ = 0.0285 | R₁ = 0.0403 |
| [I ≥ 2σ(I)] | wR₂ = 0.0564 | wR₂ = 0.1088 |
| Final R indices [all | R₁ = 0.0501 | R₁ = 0.0425 |
| data] | wR₂ = 0.0604 | wR₂ = 0.1120 |

Tables 4 and 5 show EDS data for activated 2 (Gd) and 2 (Ho), respectively, with PFHxA as modulator. The average wt. % ratio of holmium to fluorine for the activated sample is 7±0.3 close to the theoretical wt. % ratio of 7.

TABLE 4
EDS Data for Activated 2 (Gd) with PFHxA as Modulator

| Compound | Average |
|---|---|
| 2 (Gd) | Wt. % |
| C | 44.83 |
| O | 14.79 |
| F | 5.80 |
| Gd | 37.56 |
| Total | 100 |

TABLE 5
EDS Data for Activated 2 (Ho) with PFHxA as Modulator

| Compound | Average |
|---|---|
| 2 (Ho) | Wt. % |
| C | 41.08 |
| O | 13.62 |
| F | 6.44 |
| Ho | 45.18 |
| Total | 100 |

Table 6 shows EDS data for activated 2 (Ho) with PFOA as modulator. The average wt. % ratio of holmium to fluorine for the activated sample is 7±0.2 close to the theoretical wt. % ratio of 7.

TABLE 6
EDS Data for Activated 2 (Ho) with PFOA as Modulator

| Compound | Average |
|---|---|
| 2 (Ho) | Wt. % |
| C | 33.30 |
| O | 13.03 |
| F | 6.60 |
| Ho | 46.75 |
| Total | 100 |

Table 7 shows EDS data for activated 2 (Gd) with PFHxA as modulator. The average wt. % ratio of gadolinium to fluorine for the activated sample is 6.7±0.7 close to the theoretical wt. % ratio of 6.6.

TABLE 7
EDS Data for Activated 2 (Gd) with PFHxA as Modulator

| Compound | Average |
|---|---|
| 2 (Gd) | Wt. % |
| C | 43.10 |
| O | 13.79 |
| F | 5.78 |
| Gd | 39.00 |
| Total | 100 |

Table 8 shows EDS data for activated 2 (Gd) with PFOA as modulator. The average wt. % ratio of gadolinium to fluorine for the activated sample is 6.8±0.9 close to the theoretical wt. % ratio of 6.6.

TABLE 8
EDS Data for Activated 2 (Gd) with PFOA as Modulator

| Compound | Average |
|---|---|
| 2 (Gd) | Wt. % |
| C | 45.95 |
| O | 13.54 |
| F | 5.18 |
| Gd | 35.30 |
| Total | 100 |

Table 9 shows EDS data for activated 2 (Tb) with PFHxA as modulator. The average wt. % ratio of terbium to fluorine for the activated sample is 6.9±0.2 close to the theoretical wt. % ratio of 6.7.

TABLE 9
EDS Data for Activated 2 (Tb) with PFHxA as Modulator

| Compound | Average |
|---|---|
| 2 (Tb) | Wt. % |
| C | 45.75 |
| O | 14.78 |
| F | 4.88 |
| Tb | 33.91 |
| Total | 100 |

Table 10 shows EDS data for activated 2 (Tb) with PFOA as modulator. The average wt. % ratio of terbium to fluorine for the activated sample is 6.7±0.2 close to the theoretical wt. % ratio of 6.7.

TABLE 10
EDS Data for Activated 2 (Tb) with PFOA as Modulator

| Compound | Average |
|---|---|
| 2 (Tb) | Wt. % |
| C | 43.85 |
| O | 14.05 |
| F | 5.45 |
| Tb | 36.64 |
| Total | 100 |

Table 11 shows EDS data for activated 2 (Dy) with PFHxA as modulator. The average wt. % ratio of dysprosium to fluorine for the activated sample is 6.6±0.5 close to the theoretical wt. % ratio of 6.8.

TABLE 11
EDS Data for Activated 2 (Dy) with PFHxA as Modulator

| Compound | Average |
|---|---|
| 2 (Dy) | Wt. % |
| C | 39.39 |
| O | 12.47 |
| F | 6.24 |
| Dy | 41.23 |
| Total | 100 |

Table 12 shows EDS data for activated 2 (Dy) with PFOA as modulator. The average wt. % ratio of dysprosium to fluorine for the activated sample is 6.8±0.7 close to the theoretical wt. % ratio of 6.8.

TABLE 12
EDS Data for Activated 2 (Dy) with PFOA as Modulator

| Compound | Average |
|---|---|
| 2 (Dy) | Wt. % |
| C | 39.64 |
| O | 13.11 |
| F | 6.03 |
| Dy | 41.21 |
| Total | 100 |

### Conclusion

In summary, two isostructural dimeric complexes of Ho³⁺ and Gd³⁺ 1 in presence of 2-fba and 2,2′-bpy were synthesized in water. The single-crystal X-ray diffraction analyses revealed that 2-fba ions are bound to the RE metal ions. Surprisingly, the solvothermal reaction of 1 with the organic linker, H3BTB, in DMF, resulted in a fluoro-bridged nonanuclear and trinuclear cluster MOF 2 (Ho³⁺ and Gd³⁺). The presence of fluorine in 2 was confirmed with SCXRD measurements and other complementary analytical techniques such as SEM/EDS and XPS. 1 may be considered a model for the first step in the defluorination of 2-fba molecules by RE metal ions. It is also hypothesized that dimethylamine from DMF, can act as a nucleophile, and replace the fluorine. Since the organo-fluorine modulators compete with the linker for coordination to the metal ions, these results showed that per- and polyfluoroalkyl substances (PFAS) with their lower pKas are better fluoride sources for the RE MOF cluster formation. The reaction of the RE ions Ho³⁺, Gd³⁺, Dy³⁺, and Tb³⁺ with PFHxA and PFOA as modulators in presence of organic linker, H3BTB, in DMF resulted in a new fluoro-bridged nonanuclear and trinuclear cluster MOF. These MOFs were confirmed to have fluoro-bridged clusters by SEM/EDS, and XPS. It is shown that the RE ions (Ho³⁺, Gd³⁺, Dy³⁺, and Tb³⁺) can react with PFHxA and PFOA and remove the fluorine. The range of fluorinated molecules that can act as sources of fluorine for making fluoro-bridged MOFs continues to expand. Furthermore, this work unambiguously proved the potential of RE-based MOFs in PFAS remediation. The newly discovered reactivity of RE towards defluorination of PFAS would provide new direction of research for the PFAS degradation.

### Example 3: Fluorine Extraction from Organo-fluorine Molecules to Make Fluorinated Clusters in Yttrium MOFs

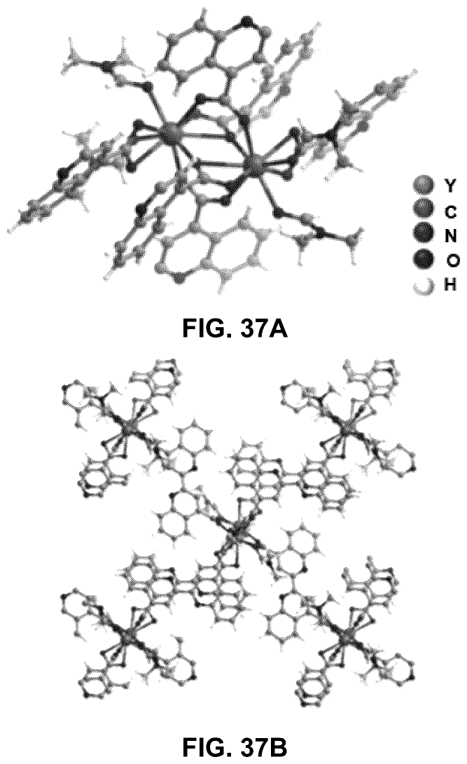

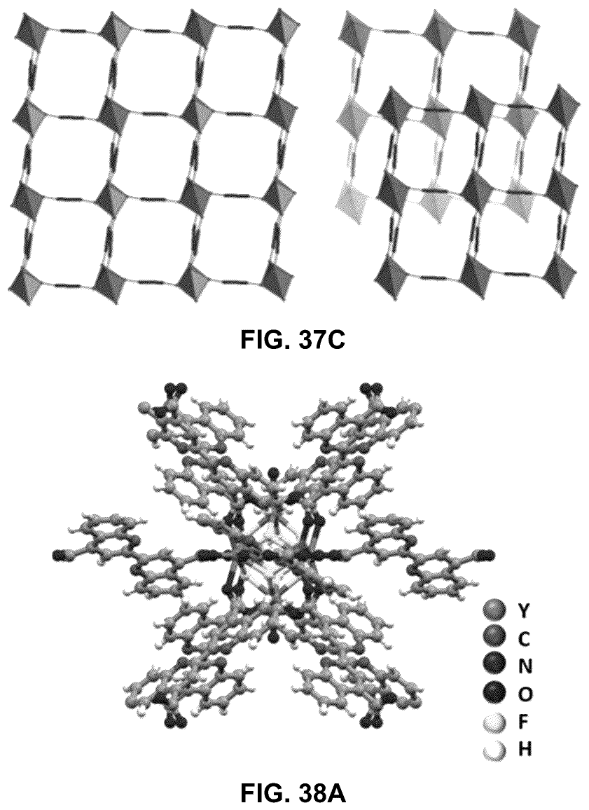

In the absence of fluorinated modulators, the solvothermal reaction of Y(NO₃)₃·6(H₂O) with the BCA ligand yielded a two dimensional MOF, [Y₂(μ₄-BCA)₂(μ₃-BCA)4(DMF)₄]ₙ·nDMF·n(H₂O) (Y-BCA-2D). Single-crystal XRD (SC-XRD) analysis reveals that Y-BCA-2D crystalizes into a triclinic space group, P1. The Y³⁺ has a coordination number of nine in the Y-BCA-2D dimer node. In the structure of Y-BCA-2D, inversion centers lie at the center of the Y-based binuclear clusters as shown in FIG. 37A. In these binuclear clusters, each Y center is coordinated to two terminal DMF molecules by the carbonyl oxygen atoms and eight carboxylate groups from the BCA ligands. There are two types of chemically distinct BCA ligands in the structure, namely type-1 and type-2. Each type-1 BCA ligand has one η²-carboxylate group chelating to a Y³⁺ ion and another μ₂, η³-carboxylate group bridging the Y³⁺ ions in the binuclear clusters. Type-2 BCA ligands are geometrically perpendicular to the type-1 BCA ligands. Each BCA linker is bound to four different Y³⁺ ions from two different binuclear clusters by its two bridging carboxylate groups. In the extended structure of Y-BCA-2D, two type-1 BCA ligands pair up and align in an antiparallel fashion, connecting two adjacent binuclear clusters and forming an infinite chain as shown in FIG. 37B. Perpendicular to this chain, type-2 BCA ligands forms another infinite chain while connecting the binuclear clusters in proximity. Topologically, the two perpendicular chains generate a two-dimensional 4-c net with the sql topology as shown in FIG. 37C. The 2D layers are aligned in a staggered configuration with the clusters being on top of the type-2 BCA ligands from an adjacent layer. The staggering alignment of these layers leads to elimination of pore space with a minimal Platon void percentage of 3%. Between each layer, there are DMF, and water molecules.

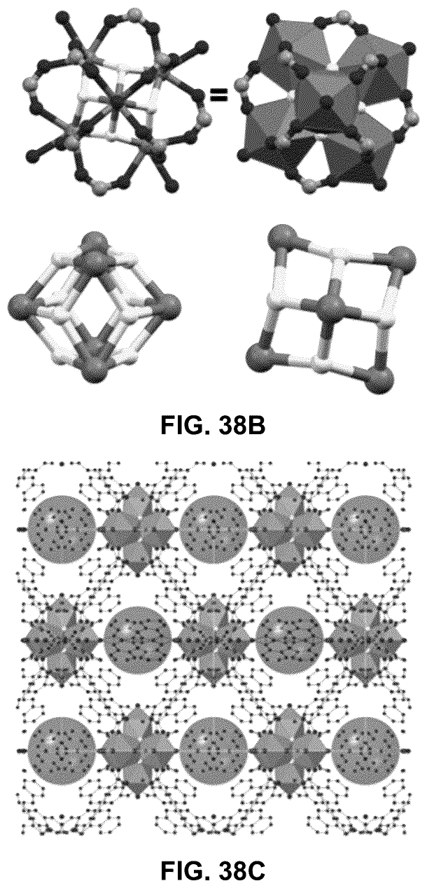

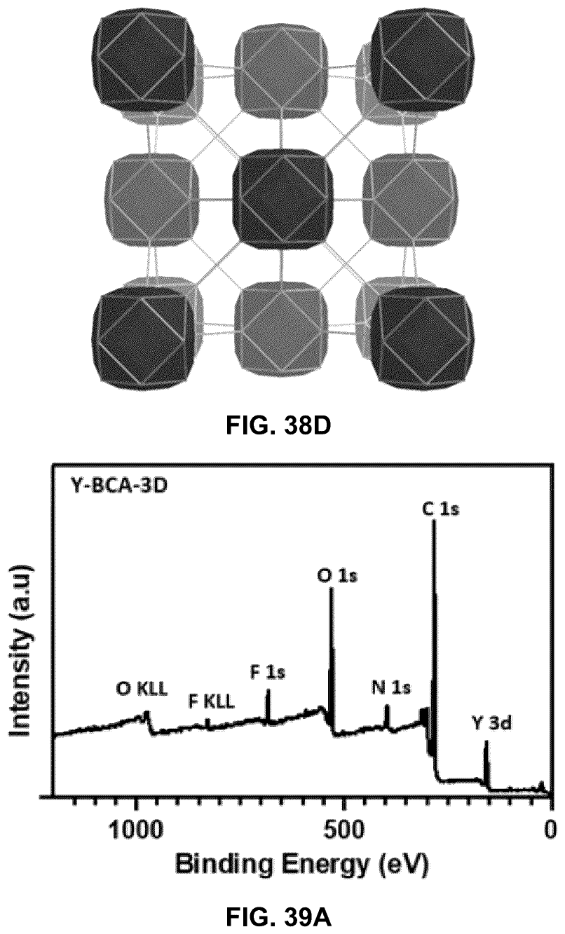

In the presence of fluorinated modulators (2-FBA, 2,6-DFBA, PFHxA), the solvothermal reaction of Y(NO₃)₃·6(H₂O) with the BCA ligand yielded a three-dimensional MOF (Y-BCA-3D) with an empirical formula of C₃₀H₁₅F2N₃O_{6.62}Y_{1.5}. Y-BCA-3D crystalized in the tetragonal space group 14/m. The crystal structure of Y-BCA-3D consists of yttrium hexanuclear clusters coordinated by BCA linkers. Yttrium has the same coordination number (i.e., CN: 9) as in the dimer, but the μ₃-F bridges form a hexanuclear cluster (Y₆F₈), as shown in FIGS. 38A-38B. Each hexanuclear cluster is connected to BCA linkers via η²-carboxylate groups. Each Y³⁺ ion is coordinated with one water molecule, four μ₃-F, and four oxygen atoms from carboxylate groups. The extended network shows that Y-BCA-3D has the same fcu topology as the UiO-66 FIGS. 38C-38D. Details of the crystallographic data collection and instrumentation are discussed in the ESI as well as the crystal parameters, and refinement details are given in Table 3. The powder XRD confirms the crystallinity and bulk purity of the product when compared to the simulated pattern from the single crystal structure.

The formation of these μ₃-F bridged hexaclusters depends on the nature of the modulator and the ratio with the BCA linker. It was found that 2-FBA gave a mixture of 2D/3D MOFs if used in a modulator/BCA mole ratio less than 15. While the same ratios of 2,6-DFBA and PFHxA only form the hexaclusters. This could reflect the lower pKₐ of BCA (1.77), which competes with the modulator for the Y³⁺ ions. The pKₐ values for the modulators are 3.27, 2.34, and −0.15 for 2-FBA, 2,6-DFBA, and PFHxA, respectively. The ideal linker to modulator mole ratios were found as 1:18, 1:14, and 1:7 for 2-FBA, 2,6-DFBA, and PFHxA, respectively. It should be noted that an excess amount of modulator in all cases resulted in a mixture of YF₃ and Y-BCA-3D. Therefore, the donor strength of the modulator versus the linker must be taken into careful consideration when designing fluoro-bridged RE-MOFs. Attempts to use NaF and NH₄F as the fluorine source in the synthesis of Y-BCA-3D only resulted in formation of yttrium fluorides. Moreover, attempts to convert the 2D MOF to the 3D MOF by heating with organo-fluorine modulators only resulted in formation of YF₃.

The EDS elemental mapping confirms the presence of fluorine in the Y-BCA-3D. The EDS of Y-BCA-3D synthesized with different fluorinated modulators show that the amount of fluorine is consistent with the theoretically calculated amount. Fluorine nuclear magnetic resonance (¹⁹F-NMR) spectroscopy was used to confirm the presence of fluorine in the MOFs. Three different samples of Y-BCA-3D synthesized using different fluorinated modulators i.e., 2-FBA, 2,6-DFBA, and PFHxA were digested in 10% deuterated sulfuric acid. ¹⁹F-NMR spectra of acid digested Y-BCA-3D confirmed that there were no trapped modulators inside the MOF pores, as the fluorine chemical shifts do not match the modulators. The chemical shift peaks at −169 ppm correspond to hydrofluoric acid (HF) formed by the release of bridging fluorine from the digested MOF, as these peaks are in the same region as the reported ¹⁹F-NMR peak for HF.

It should be noted that the only source of fluorine was the organo-fluorine molecules (2-FBA, 2,6-DFBA, or PFHxA). It was confirmed that the fluorine in the Y-BCA-3D is present in the metal nodes, and not unreacted or trapped organo-fluorine molecules. As a proof of fluorine extraction, a reaction of just the modulator and Y³⁺ was carried out without the organic linker. The Y³⁺ can extract fluorine from 2-FBA, 2,6-DFBA and PFHxA to make YF₃. The formation of YF₃ was confirmed by comparing the powder XRD with its simulated pattern, and no impurities were found.

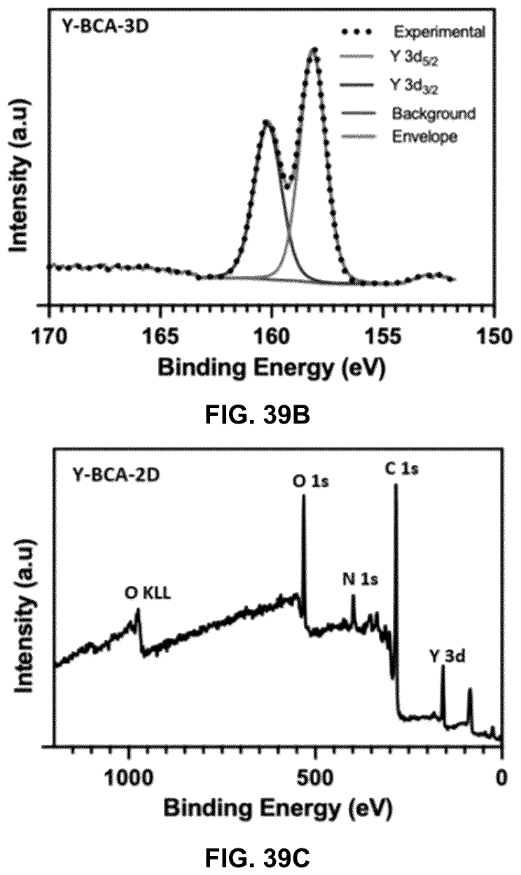

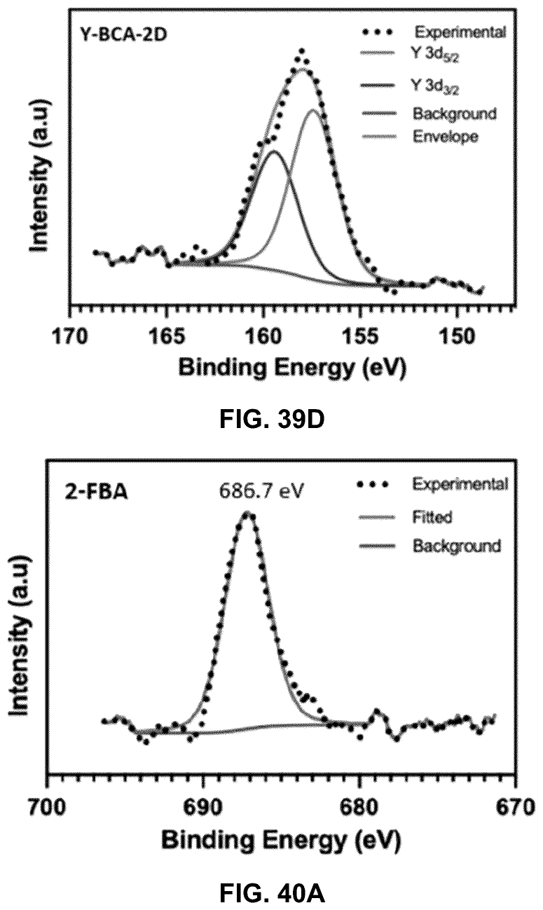

The presence of elemental chemical states can be precisely determined by the XPS. The survey spectra of the 2D and 3D MOFs shown in FIGS. 39A and 39C confirms the presence of yttrium, fluorine, and BCA linker elements i.e., carbon, nitrogen, and oxygen. The high-resolution spectrum of Y-BCA-3D gave spin-orbit coupled peaks of Y 3d_{5/2} and 3d_{3/2} at 158.2 eV and 160.2 eV, respectively. The Y-BCA-2D shows a binding energy (BE) of Y 3d_{5/2} at 157.4 eV. As, Y-BCA-2D only has yttrium-oxygen bonds, similar to Y₂O₃, whereas the BE of Y 3d_{5/2} in YF₃ is 159 eV due to Y—F bonds. In the case of Y-BCA-3D, these energies correspond to yttrium bound to oxygen and fluorine (O—Y—F) in the hexacluster. Hence, the Y 3d5/2 BE in the hexacluster is in between the Y₂O₃ and YF₃.

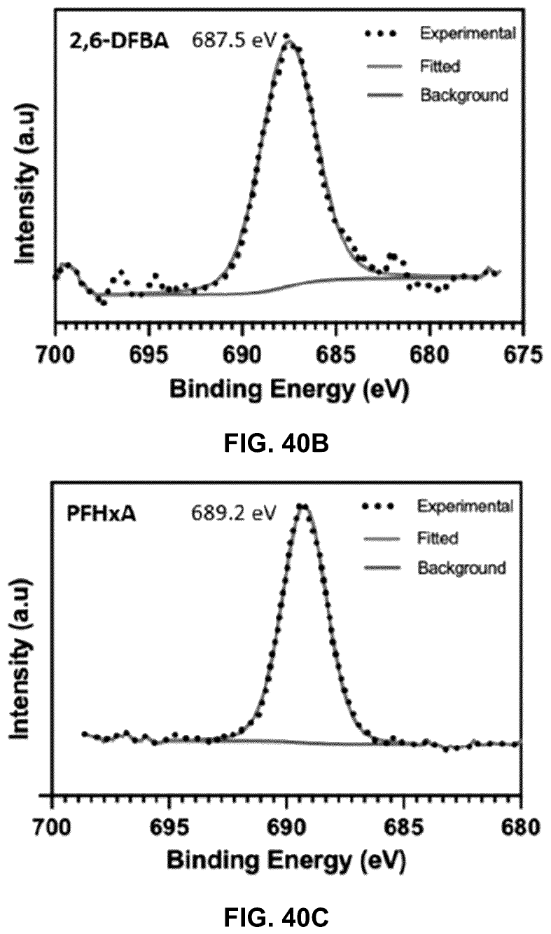

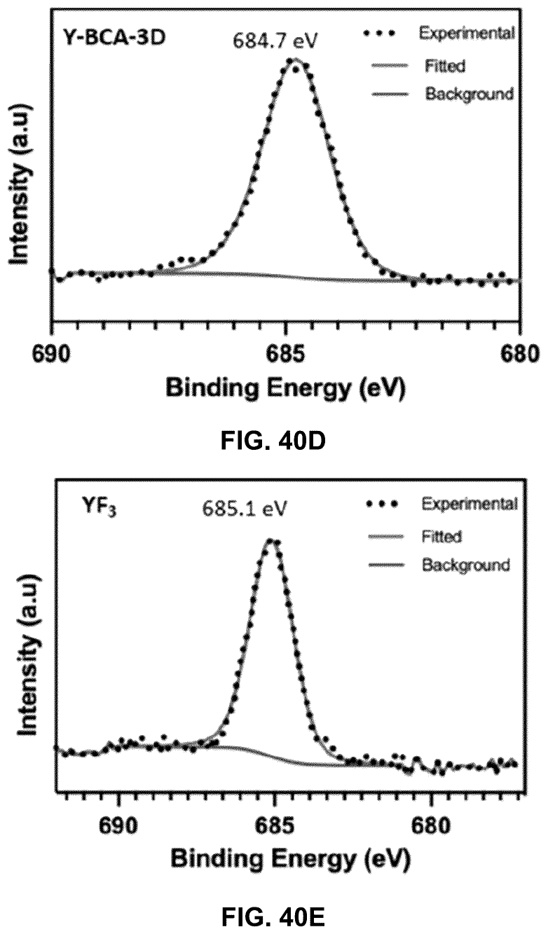

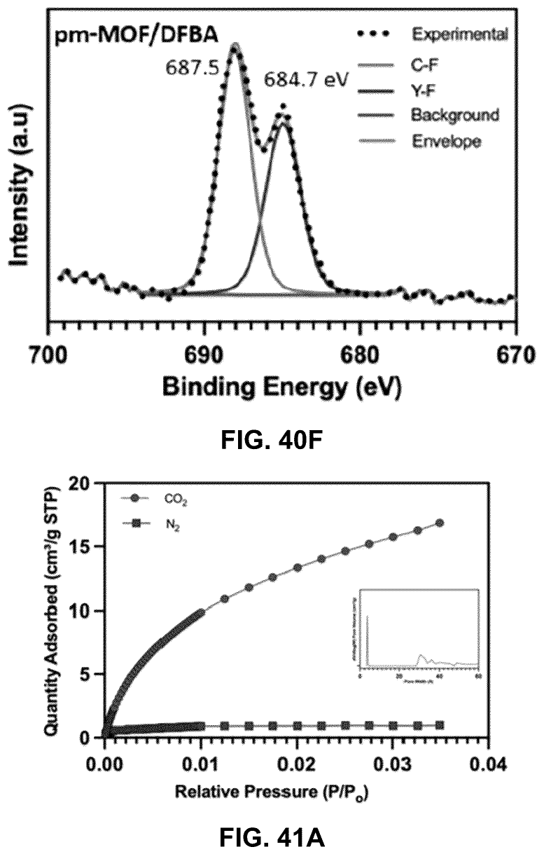

The F 1s high resolution XPS spectra show the BE for C—F in 2-FBA, 2,6-DFBA and PFHxA as 686.7, 687.5, and 689.2 eV, respectively FIGS. 40A-40C. Whereas the Y-BCA-3D shows a peak at 684.7 eV, which corresponds to fluorine bound to yttrium. This can be compared to YF₃ at 685.1 eV for F 1s. The F 1s spectrum for a physical mixture of Y-BCA-3D and 2,6-DFBA was recorded. FIG. 40F shows that the mixture has two distinct chemical states of fluorine with binding energies at 684.7 and 687.5 eV for Y—F and C—F, respectively. Hence, it can be concluded that the fluorine is bound to yttrium in the hexacluster, and no free organic fluorine is present in the Y-BCA-3D.

Thermogravimetric analysis of the MOFs activated at 160° C. under vacuum shows that the 2D-MOF decomposes around 460° C. in air and at 500° C. under a nitrogen atmosphere. Whereas the pristine BCA linker decomposes at 300° C. under air. The Y-BCA-2D structure loses 5% mass around 100° C. and is assigned to the loss of adsorbed water. A further 5% mass loss at 300° C. is assigned to coordinated DMF. Similarly, the 3D-MOF also has superior stability in comparison to the BCA linker and stable up to 450° C. It gave a 7% weight loss at 100° C. for trapped water molecules, which show that it has relatively more free volume in comparison to Y-BCA-2D.

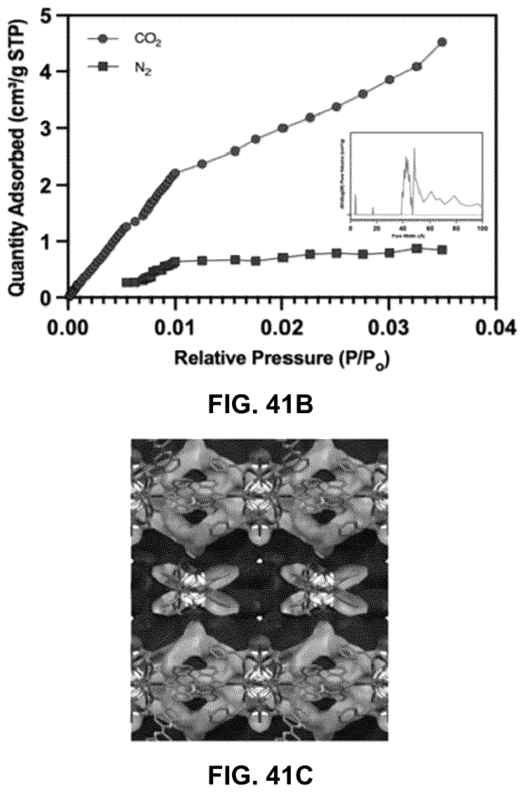

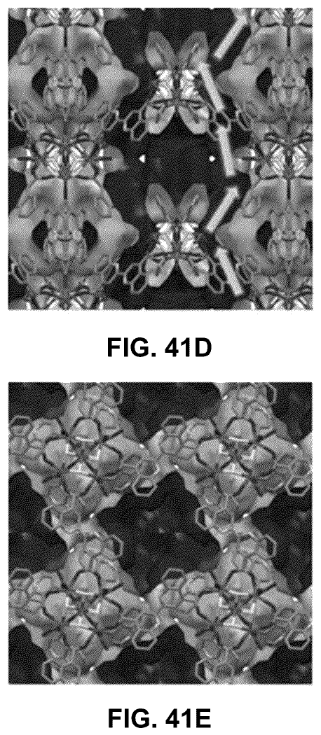

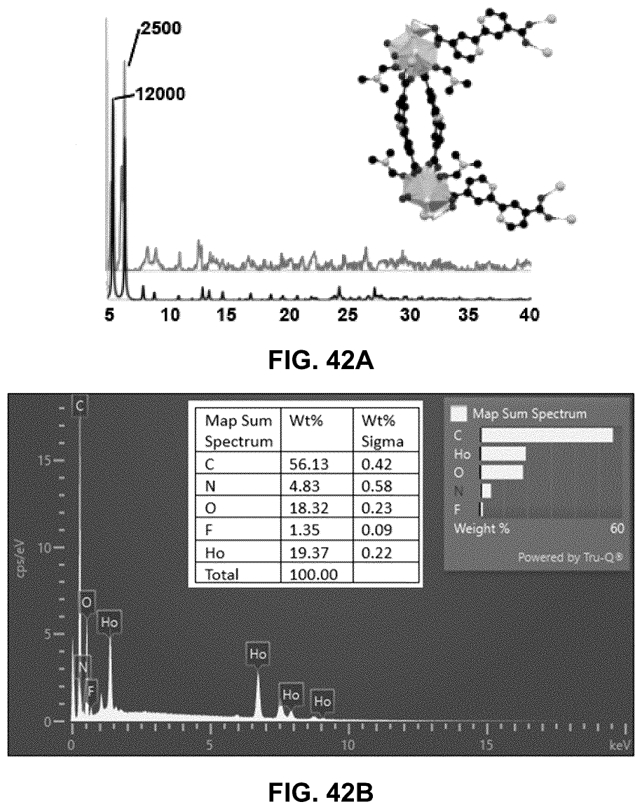

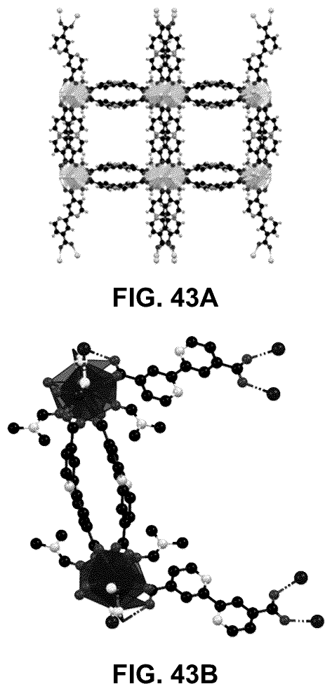

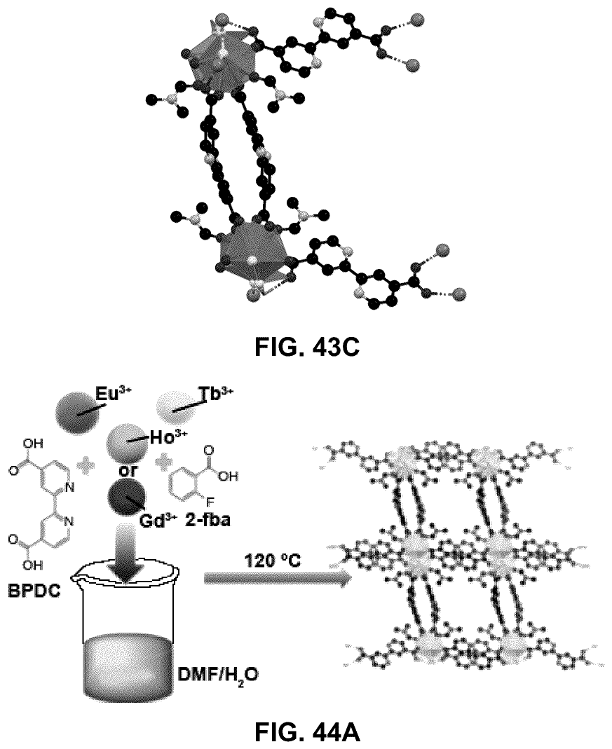

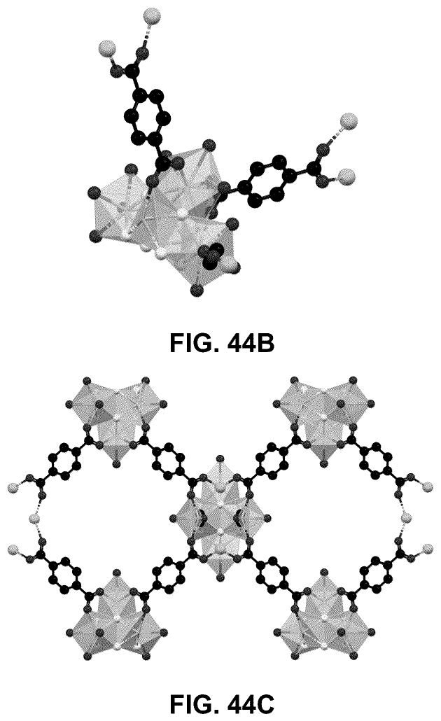

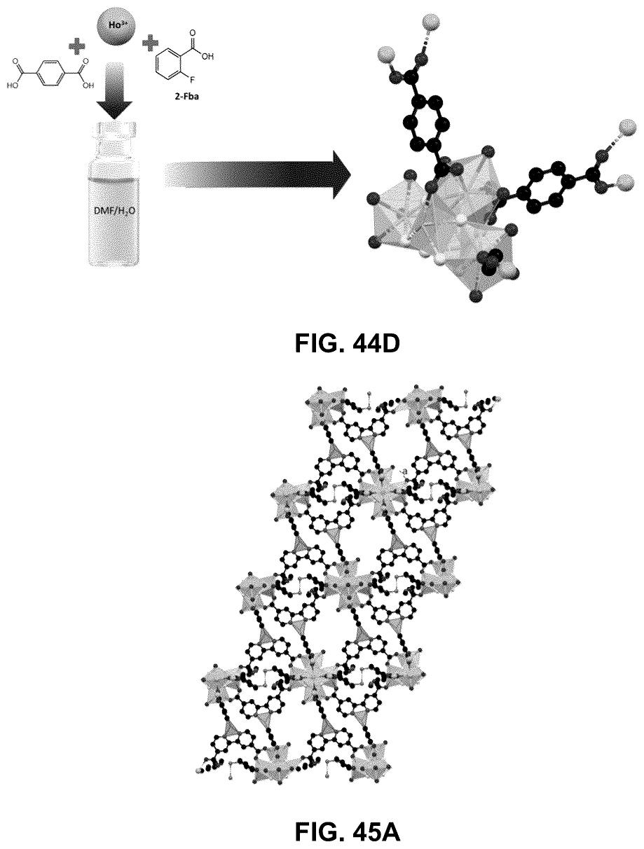

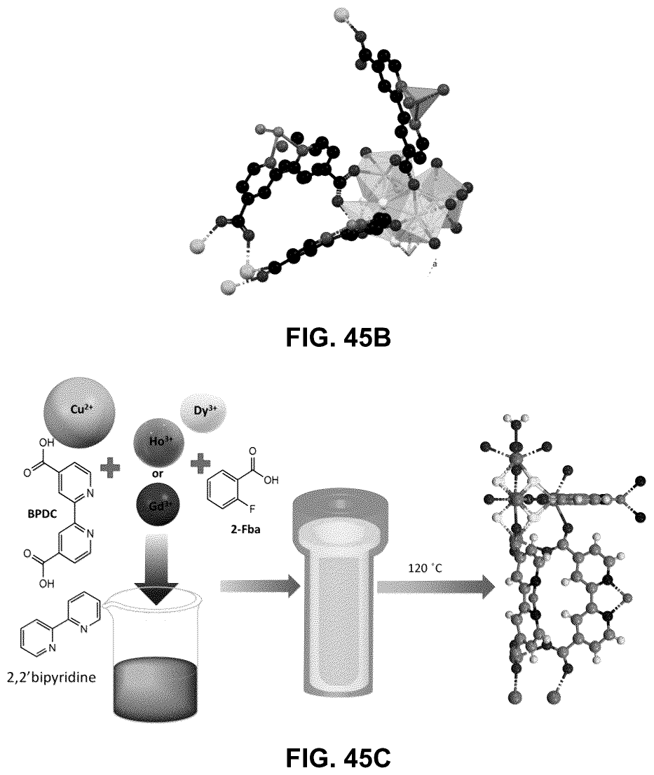

The porosity of the MOFs was probed using ultra high purity nitrogen and carbon dioxide. The nitrogen adsorption-desorption analysis shows that the activated Y-BCA-2D is a densely packed material with a very low BET surface area of 11.5 m² g⁻¹, whereas the CO₂ adsorption data shows a surface area of 33.1 m² g⁻¹ that indicates the presence of some microporosity. Similarly, the nitrogen adsorption isotherm for Y-BCA-3D MOF shows a surface area of 5.7 m² g⁻¹ and 94.5 m² g⁻¹ for the CO₂ adsorption isotherm. The surface area for the similar linker i.e., BPDC in a Gd-trinuclear cluster-based MOF is 177.7 m² g⁻¹. This shows that the Y-BCA-3D has less surface area, but it is selective for CO₂ uptake due to its narrow pore openings. Even though FIG. 41C shows that Y-BCA-3D has 6.3 Å spherical cavities, bigger than the kinetic diameter of nitrogen (3.64 Å), it does not allow N₂ adsorption. The calculated void spaces show that the channels are zigzag along a and b-axes (FIGS. 41C-41E). These channels have narrow openings ˜4 Å along the a and b-axes and have deep spherical cage type 6.3 Å cavities along c-direction. These cavities dead end along the c-axis but are accessible through the a and b axes. This was experimentally verified by the pore volume calculated by gas sorption data as shown in FIGS. 41A-41B.

### Conclusions

The extraction of fluorine from various organo-fluorine compounds by rare earth metal ions has opened up a new area for MOFs synthesis. A new yttrium MOF with the BCA linker features a fluorine bridged hexacluster. The Y³⁺ ions can extract fluorine from aromatic and aliphatic carbons. This work is currently being extended to other rare earth metal ions, as different RE metals exhibit various fluorine affinities. Understanding how the fluorine affinities play a role in the cluster formation can provide insights into the design of these MOFs as well as their potential application in fluorine sensing and extraction. The fluorine bridges found in these clusters are expected to have an effect on the optical properties of the MOFs, and those studies are in progress.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Abbas, M. et al., Fluorine extraction from organofluorine molecules to make fluorinated clusters in yttrium MOFs. Chem. Sci. 2022, 13:14285.
2. AbdulHalim, R. G.; et al, A Fine-Tuned Metal-Organic Framework for Autonomous Indoor Moisture Control. J. Am. Chem. Soc. 2017, 139 (31), 10715-10722.
3. Ahsan Usman, M. et al, Inorg. Chim. Acta, 2021, 521, 120305.
4. Alezi, D. et al, J. Am. Chem. Soc., 2015, 137, 5421-5430.
5. Amemiya, E.; et al, Rhenium versus cadmium: an alternative structure for a thermally stable cadmium carbonyl compound. Chem. Sci. 2020, 11 (43), 11763-11776.
6. Angeli, G. K.; et al, Reticular Chemistry and the Discovery of a New Family of Rare Earth (4, 8)-Connected Metal-Organic Frameworks with csq Topology Based on RE4(μ3-O)2(COO)8 Clusters. ACS Appl. Mater. Interfaces 2017, 9 (51), 44560-44566.
7. Angeli, G. K. et al, J. Am. Chem. Soc., 2021, 143, 10250-10260.
8. Assen, A. H. et al, Angew. Chem., Int. Ed., 2015, 54, 14353-14358.
9. Basnayake, S. A.; et al. Carbonate-Based Zeolitic Imidazolate Framework for Highly Selective CO2 Capture. Inorg. Chem. 2015, 54 (4), 1816-1821.
10. Bhatt, P. M.; et al, Isoreticular rare earth fcu-MOFs for the selective removal of H2S from CO2 containing gases. Chem. Eng. J. 2017, 324 (Supplement C), 392-396.
11. Bhatt, P. M. et al, J. Am. Chem. Soc., 2016, 138, 9301-9307.
12. Bicalho, H. A.; et al. Remodelling a shp: Transmetalation in a Rare-Earth Cluster-Based Metal-Organic Framework. Inorg. Chem. 2021, 60 (16), 11795-11802.
13. Briggs, D. X-Ray Photoelectron Spectroscopy (XPS). Handb. Adhes. Second Ed. 2005, 621-622.
14. Bruker-Nano APEX3: Suite for Crystallographic Software. Single Crystal, V2019; Bruker Nano Inc: Madison WI, 2019.
15. Buck, R. C.; et al. Perfluoroalkyl and Polyfluoroalkyl Substances in the Environment: Terminology, Classification, and Origins. Integr. Environ. Assess. Manag. 2011, 7 (4), 513-541.
16. Burns, C. J.; et al, Preparation and crystal structure of the mixed-valence (Yb,) tetranuclear complex, (Me5C5)6Yb(p-F)4. J. Chem. Soc., Chem. Commun. 1987, (4), 272-273.
17. Cadiau, A.; et al, Hydrolytically stable fluorinated metal-organic frameworks for energy-efficient dehydration. Science 2017, 356 (6339), 731-735.
18. Cavka, J. H. et al, J. Am. Chem. Soc., 2008, 130, 13850-13851.
19. Chakarova, K.; et al. Evolution of acid and basic sites in UiO-66 and UiO-66-NH2 metal-organic frameworks: FTIR study by probe molecules. Microporous Mesoporous Mater. 2019, 281, 110-122.
20. Chen, K. et al, Chem. Soc. Rev., 2022, 51, 1139-1166.
21. Chen, L.; et al. Metal-Organic Frameworks Featuring 18-Connected Non-anuclear Rare-Earth Oxygen Clusters and Cavities for Efficient C2H2/CO2 Separation. Inorg. Chem. 2021, 60 (17), 13471-13478.
22. Chen, Y. et al, J. Am. Chem. Soc., 2018, 140, 5678-5681.
23. Chen, Y.; et al, Microporous lanthanide metal-organic frameworks. Rev. Inorg. Chem. 2012, 32 (2-4), 81-100.
24. Chen, Z.; et al, Applying the Power of Reticular Chemistry to Finding the Missing alb-MOF Platform Based on the (6,12)-Coordinated Edge-Transitive Net. J. Am. Chem. Soc. 2017, 139 (8), 3265-3274.
25. Choi, J. Y. et al, ACS Nano, 2022, 16, 3145-3151.
26. Christe, K. O. et al, J. Fluorine Chem., 1990, 46, 339-342.
27. Christian, M. S. et al, J. Am. Chem. Soc., 2022, 2, 1889-1898.
28. Clark, D. T.; et al, An ESCA study of the molecular core binding energies of the fluorobenzenes. J. Electron. Spectrosc. Relat. Phenom. 1972, 1 (3), 227-250.
29. Cole, K. M. et al, Surf. Sci. Spectra, 2020, 27, 024010.
30. Cousins, I. T. et al, Environ. Sci.: Processes Impacts, 2020, 22, 2307-2312.
31. de Lourdes Gonzalez-Juarez, M. et al, ACS Appl. Mater. Interfaces, 2022, 14, 12404-12411.
32. Deacon, G. B.; et al, Intramolecular Metal-Fluorocarbon Coordination, C—F Bond Activation and Lanthanoid-Fluoride Clusters with Tethered Polyfluorophenylamide Ligands. Chem. Eur. J. 2009, 15 (13), 3082-3092.
33. Deacon, G. B.; et al, Manipulation of reaction pathways in redox transmetallation-ligand exchange syntheses of lanthanoid(ii)/(iii) aryloxide complexes. Dalton Trans. 2006, (6), 802-812.
34. Deacon, G. B.; et al, The effects of light lanthanoid elements (La, Ce, Nd) on (Ar)CF-Ln coordination and C—F activation in N,N-dialkyl-N′-2,3,5,6-tetrafluorophenylethane-1,2-diaminate complexes. Dalton Trans. 2012, 41 (28), 8624-8634.
35. Della Rocca, J.; et al. Nanoscale Metal-Organic Frameworks for Biomedical Imaging and Drug Delivery. Acc. Chem. Res. 2011, 44 (10), 957-968.
36. Deneff, J. I. et al, ACS Appl. Mater. Interfaces, 2022, 14, 3038-3047.
37. Diring, S.; et al. Controlled Multiscale Synthesis of Porous Coordination Polymer in Nano/Micro Regimes. Chem. Mater. 2010, 22 (16), 4531-4538.
38. Dobele, M.; et al. Synthesis of aryl fluorides on a solid support and in solution by utilizing a fluorinated solvent. Angew. Chem., Int. Ed. 2010, 49 (34), 5986-8.
39. Dolomanov, 0. V.; et al, OLEX2: a complete structure solution, refinement and analysis program. Journal of Applied Crystallography 2009, 42 (2), 339-341.
40. Donnarumma, P. R.; et al, Synthetic approaches for accessing rare-earth analogues of UiO-66. Chem. Commun. 2021, 57 (50), 6121-6124.
41. Duan, X.; et al, Highly stable Y(iii)-based metal organic framework with two molecular building block for selective adsorption of C2H2 and CO2 over CH4. Inorg. Chem. Front. 2018, 5 (5), 1193-1198.
42. Duan, Z. et al, ACS Appl. Mater. Interfaces, 2020, 12, 18715-18722.
43. Eddaoudi, M.; et al. Modular Chemistry: Secondary Building Units as a Basis for the Design of Highly Porous and Robust Metal-Organic Carboxylate Frameworks. Acc. Chem. Res. 2001, 34 (4), 319-330.
44. Eisenstein, O.; et al, Selectivity of C—H Activation and Competition between C—H and C—F Bond Activation at Fluorocarbons. Chem. Rev. 2017, 117 (13), 8710-8753.
45. Evich, M. G. et al, Science, 2022, 375(6580).
46. Fadley, C. S. X-Ray Photoelectron Spectroscopy: Progress and Perspectives. J. Electron Spectros. Relat. Phenomena 2010, 178-179 (C), 2-32.
47. Feng, J. F.; et al. Dual-Emitting UiO-66(Zr&Eu) Metal-Organic Framework Films for Ratiometric Temperature Sensing. ACS Appl. Mater. Interfaces 2018, 10 (24), 20854-20861.
48. Feng, L. et al, Molecular Pivot-Hinge Installation to Evolve Topology in Rare-Earth Metal-Organic Frameworks. Angew. Chem. Int. Ed. 2019, 58 (46), 16682-16690.
49. Feng, T. et al, Angew. Chem., 2020, 132, 21936-21941.
50. Feng, X. et al, Chem. Sci., 2019, 10, 2193-2198.
51. Feng, Y. et al, Cryst. Growth Des., 2019, 19, 1509-1513.
52. Firouzi, H. R.; et al. Mechanistic Study of Fluorine Extraction from 2-Fluorobenzoic Acid by Rare-Earth Ions. Unpubl. results 2022.
53. Forgan, R. S. Chem. Sci., 2020, 11, 4546-4562.
54. Furukawa, H. et al, J. Am. Chem. Soc., 2014, 136, 4369-4381.
55. Furukawa, H.; et al. The Chemistry and Applications of Metal-Organic Frameworks. Science (80-.). 2013, 341 (6149).
56. Gao, M. L. et al, Inorg. Chem., 2017, 56, 511-517.
57. Garcia, J.; et al. General Method for Nucleophilic Aromatic Substitution of Aryl Fluorides and Chlorides with Dimethylamine Using Hydroxide-Assisted Decomposition of N,N-Dimethylforamide. Synth. Commun. 2016, 46 (5), 475-481.
58. Giannetti, E. Thermal Stability and Bond Dissociation Energy of Fluorinated Polymers: A Critical Evaluation. J. Fluor. Chem. 2005, 126 (4), 623-630.
59. Gu, Z. Y. et al, ChemCatChem, 2014, 6, 67-75.
60. Guillerm, V. et al, Nat. Chem., 2014, 6(8), 673-680.
61. Guo, X.; et al. A Lanthanide Metal-Organic Framework with High Thermal Stability and Available Lewis-Acid Metal Sites. Chem. Commun. 2006, No. 30, 3172-3174.
62. Health, P. N. Perfluoroalkyl and Polyfluoroalkyl Substances (PFAS). Pediatr. Environ.

Heal. 2021, No. March, 627-640.
63. Horcajada, P.; et al. Metal-Organic Frameworks as Efficient Materials for Drug Delivery.

Angew. Chemie 2006, 118 (36), 6120-6124.
64. Howarth, A. J.; et al, Best Practices for the Synthesis, Activation, and Characterization of Metal-Organic Frameworks. Chem. Mater. 2016, 29 (1), 26-39.
65. Hu, F. et al Cryst. Growth Des., 2019, 19, 6381-6387.
66. Hudlicky, M. J. Fluorine Chem., 1985, 28, 461-472.
67. Huo, J. et al, Chem. Sci., 2015, 6, 1938-1943.
68. Jiang, H. et al, J. Am. Chem. Soc., 2018, 140, 8858-8867.
69. Kalmutzki, M. J. et al, Adv. Mater., 2018, 30, 1704304.
70. Klaassen, N. J. M.; et al, The various therapeutic applications of the medical isotope holmium-166: a narrative review. EJNMMI Radiopharm. Chem. 2019, 4 (1), 19.
71. Kourtellaris, A. et al, Adv. Opt. Mater., 2022, 2200484.
72. Lawson, H. D. et al, ACS Appl. Mater. Interfaces, 2021, 13, 7004-7020.
73. Li, D.; et al. Metal-Organic Frameworks for Catalysis: State of the Art, Challenges, and Opportunities. Energy Chem 2019, 1 (1), 100005.
74. Li, H.-X.; et al. Synthesis, Structure and High Methane Storage of Pure D6R Yb(Y) Nonanuclear Cluster-Based Zeolite-like Metal-Organic Frameworks. J. Mater. Chem. A 2022, 10 (28), 14795-14798.
75. Li, Q. et al, Inorg. Chem., 2021, 60, 8143-8153.
76. Li, X., et al. Crystal Structure of Bis(2,2′-Bipy Ridine)Tetrakis(μ-2-Fluorobenzoato-O,O′)-Bis(2-Fluorobenzoato)Disamarium(III), Sm2(C7H4FO2)6(C10H8N2)2. Zeitschrift für Krist.—New Cryst. Struct. 2004, 219 (1-4), 451-452.
77. Li, Y. J. et al, Inorg. Chem., 2017, 56, 2159-2164.
78. Lin, W.; et al. Snapshots of Postsynthetic Modification in a Layered Metal-Organic Framework: Isometric Linker Exchange and Adaptive Linker Installation. Inorg. Chem. 2021, 60 (16), 11756-11763.
79. Ling, B. K. et al, Chem. Commun., 2020, 56, 9130-9133.
80. Liu, C. et al, Chem. Sci., 2018, 9, 8099-8102.
81. Liu, G.; et al, Mixed matrix formulations with MOF molecular sieving for key energy-intensive separations. Nat. Mater. 2018, 17 (3), 283-289.
82. Liu, J.-J.; et al. Per- and Perfluoroalkyl Substances Alternatives, Mixtures and Liver Function in Adults: A Community-Based Population Study in China. Environ. Int. 2022, 163, 107179.
83. Luebke, R. et al, Chem. Sci., 2015, 6, 4095-4102.
84. Luo, J.; et al. Hydrogen Adsorption in a Highly Stable Porous Rare-Earth Metal-Organic Framework: Sorption Properties and Neutron Diffraction Studies. J. Am. Chem. Soc. 2008, 130 (30), 9626-9627.
85. Lv, X. L. et al, J. Am. Chem. Soc., 2021, 143, 2784-2791.
86. Lv, X.-L.; et al, A Series of Mesoporous Rare-Earth Metal-Organic Frameworks Constructed from Organic Secondary Building Units. Angew. Chem. Int. Ed. 2021, 60 (4), 2053-2057.
87. Moore, J. T. et al, J. Am. Chem. Soc., 2020, 142, 11641-11646.
88. Mortensen, M. L. et al, Crystals, 2021, 11, 1547.
89. N'Dala-Louika, I. et al, J. Mater. Chem. C, 2017, 5, 10933-10937.
90. Ni, K. et al, Chem. Sci., 2020, 11, 7641-7653.
91. Ni, K. et al, Nat. Biomed. Eng., 2022, 6(2), 144-156.
92. Niu, Z. D.; et al. A lithium-modified zirconium-based metal organic framework (UiO-66) for efficient CO2 adsorption. New J. Chem. 2018, 42 (24), 19764-19770.
93. Norton, K.; et al, Lanthanide Compounds with Fluorinated OC6F5 Ligands: Homo- and Heterovalent Complexes of Eu(II) and Eu(III). Inorg. Chem. 2007, 46 (10), 4060-4066.
94. O'Hagan, D. Understanding Organofluorine Chemistry. An Introduction to the C—F Bond.

Chem. Soc. Rev. 2008, 37 (2), 308-319.
95. Olorunyomi, J. F.; et al. Metal-Organic Frameworks for Chemical Sensing Devices. Mater.

Horizons 2021, 8 (9), 2387-2419.
96. Pagis, C.; et al, Lanthanide-Based Metal Organic Frameworks: Synthetic Strategies and Catalytic Applications. ACS Catalysis 2016, 6 (9), 6063-6072.
97. Panagiotou, N. et al, Inorg. Chem. Front., 2022, 9, 4850-4863.
98. Planas, N.; et al. Defining the Proton Topology of the Zr6-Based Metal-Organic Framework NU-1000. J. Phys. Chem. Lett. 2014, 5 (21), 3716-23.
99. Pramann, A.; et al, Photoelectron Spectroscopy of Yttrium Oxide Cluster Anions: Effects of Oxygen and Metal Atom Addition. J. Phys. Chem. A 2001, 105 (32), 7534-7540.
100. Quezada-Novoa, V.; et al, Building a shp: A Rare-Earth Metal-Organic Framework and Its Application in a Catalytic Photooxidation Reaction. Chem. Mater. 2021, 33 (11), 4163-4169.
101. Rahman, M. F.; et al. Behaviour and Fate of Perfluoroalkyl and Polyfluoroalkyl Substances (PFASs) in Drinking Water Treatment: A Review. Water Res. 2014, 50, 318-340.
102. Rayne, S.; et al. Theoretical Studies on the PKα Values of Perfluoroalkyl Carboxylic Acids. J. Mol. Struct. THEOCHEM 2010, 949 (1-3), 60-69.
103. Reineke, T. M.; et al, A Microporous Lanthanide-Organic Framework. Angew. Chem. Int. Ed. 1999, 38 (17), 2590-2594.
104. Reineke, T. M.; et al, From Condensed Lanthanide Coordination Solids to Microporous Frameworks Having Accessible Metal Sites. J. Am. Chem. Soc. 1999, 121 (8), 1651-1657.
105. Rosi, N. L.; et al. Advances in the Chemistry of Metal-Organic Frameworks. Cryst. Eng. Comm. 2002, 4 (68), 401-404.
106. Saraci, F. et al, Chem. Soc. Rev., 2020, 49, 7949-7977.
107. Sava Gallis, D. F.; et al, Multifunctional, Tunable Metal-Organic Framework Materials Platform for Bioimaging Applications. ACS Appl. Mater. Interfaces 2017, 9 (27), 22268-22277.
108. Sava Gallis, D. F.; et al, NOx Adsorption and Optical Detection in Rare Earth Metal-Organic Frameworks. ACS Appl. Mater. Interfaces 2019, 11 (46), 43270-43277.
109. Sava Gallis, D. F. et al, J. Mater. Chem. A, 2018, 6, 3038-3045.
110. Schulte, Z. M. et al, Chem. Sci., 2020, 11, 12807-12815.
111. Seah, M. P., A review of the analysis of surfaces and thin films by AES and XPS. Vacuum 1984, 34 (3), 463-478.
112. Sheldrick, G. M., SADABS, program for empirical absorption correction of area detector data. University of Göttingen, Germany Göttingen, Germany: 1996.
113. Sheldrick, G., A short history of SHELX. Acta Crystallographica Section A 2008, 64 (1), 112-122.
114. Sheldrick, G., SHELXT—Integrated space-group and crystal-structure determination. Acta Crystallographica Section A 2015, 71 (1), 3-8.
115. Sheybani, S. et al. Synthesis of Fluoro-Bridged Ho3+ and Gd3+ 1,3,5-Tris(4-carboxyphenyl)benzene Metal-Organic Frameworks from Perfluoroalkyl Substances. Inorg. Chem. 2023, 62:4314-4321.
116. Shi, Y.; et al, Holmium for Use in Cancer Therapy. Comment. Inorg. Chem. 2017, 37 (6), 281-300.
117. Skorupskii, G. et al, Proc. Natl. Acad. Sci. U.S.A, 2022, 119, e2205127119.
118. Spek, A. L., PLATON SQUEEZE: a tool for the calculation of the disordered solvent contribution to the calculated structure factors. Acta Crystallographica Section C: Structural Chemistry 2015, 71 (1), 9-18.
119. Stodolka, M. et al, ACS Cent. Sci., 2022, 8, 877-879.
120. Sunderland, E. M.; et al. A Review of the Pathways of Human Exposure to Poly- and Perfluoroalkyl Substances (PFASs) and Present Understanding of Health Effects. J. Expo. Sci. & amp; Environ. Epidemiol. 2019, 29 (2), 131-147.
121. Takemura, H.; et al, A Study of C—F . . . M+ Interaction: Metal Complexes of Fluorine-Containing Cage Compounds. J. Am. Chem. Soc. 2001, 123 (38), 9293-9298.
122. Tougaard, S. Surface Analysis|X-Ray Photoelectron Spectroscopy, Third Edit.; Elsevier, 2019; Vol. 9.
123. Trannoy, V. et al, Adv. Opt. Mater., 2021, 9, 2001938.
124. Tsuruoka, T.; et al. Nanoporous Nanorods Fabricated by Coordination Modulation and Oriented Attachment Growth. Angew. Chemie 2009, 121 (26), 4833-4837.
125. Ugale, B.; et al. Exceptionally Stable and 20-Connected Lanthanide Metal-Organic Frameworks for Selective CO2 Capture and Conversion at Atmospheric Pressure. Cryst. Growth & amp; Des. 2018, 18 (4), 2432-2440.
126. Umemura, A.; et al. Morphology Design of Porous Coordination Polymer Crystals by Coordination Modulation. J. Am. Chem. Soc. 2011, 133 (39), 15506-15513.
127. Vizuet, J. P. et al, J. Am. Chem. Soc., 2021, 143, 17995-18000.
128. Vizuet, J. P. et al, J. Nanosci. Nanotechnol., 2019, 20, 3019-3024.
129. Vizuet, J. P. et al, Polyhedron, 2019, 159, 12-17.
130. Wang, H.; et al, Tailor-Made Microporous Metal-Organic Frameworks for the Full Separation of Propane from Propylene Through Selective Size Exclusion. Adv. Mater. 2018, 30 (49), 1805088.
131. Wang, L.; et al. Metal-Organic Frameworks for Energy Storage: Batteries and Supercapacitors. Coord. Chem. Rev. 2016, 307, 361-381.
132. Wang, P.-P.; et al. General Synthesis and Characterization of a Family of Layered Lanthanide (Pr, Nd, Sm, Eu, and Gd) Hydroxide Nanowires. Nanoscale 2011, 3 (6), 2529.
133. Wang, X. R.; et al. Hydrothermal Preparation of Five Rare-Earth (Re=Dy, Gd, Ho, Pr, and Sm) Luminescent Cluster-Based Coordination Materials: The First MOFs-Based Ratiometric Fluorescent Sensor for Lysine and Bifunctional Sensing Platform for Insulin and Al3+. Inorg. Chem. 2018, 57 (20), 12885-12899.
134. Wang, Y.; et al, Topology Exploration in Highly Connected Rare-Earth Metal-Organic Frameworks via Continuous Hindrance Control. J. Am. Chem. Soc. 2019, 141 (17), 6967-6975.
135. Wang, Y.; et al. Missing-node directed synthesis of hierarchical pores on a zirconium metal-organic framework with tunable porosity and enhanced surface acidity via a microdroplet flow reaction. J. Mater. Chem. A 2017, 5 (42), 22372-22379.
136. Wannapaiboon, S. et al, J. Mater. Chem. A, 2017, 5, 13665-13673.
137. Watson, P. L.; et al, Defluorination of perfluoroolefins by divalent lanthanoid reagents: activating carbon-fluorine bonds. Organometallics 1990, 9 (7), 1999-2009.
138. Wei, N. et al, Chem. Commun., 2017, 53, 3224-3227.
139. Wen, Y. et al, J. Am. Chem. Soc., 2022, 144, 11840-11850.
140. Xia, H.-L.; et al. Amino Group Induced Structural Diversity and Near-Infrared Emission of Yttrium-Tetracarboxylate Frameworks. Chem. Sci. 2022.
141. Xia, T. et al, Dalton Trans., 2022, 51, 5426-5433.
142. Xiao, F. Emerging Poly- and Perfluoroalkyl Substances in the Aquatic Environment: A Review of Current Literature. Water Res. 2017, 124, 482-495.
143. Xue, D. X. et al, J. Am. Chem. Soc., 2013, 135, 7660-7667.
144. Xue, D. X. et al, J. Am. Chem. Soc., 2015, 137, 5034-5040.
145. Xue, D.-X.; et al, Topology meets MOF chemistry for pore-aperture fine tuning: ftw-MOF platform for energy-efficient separations via adsorption kinetics or molecular sieving. Chem. Commun. 2018, 54 (49), 6404-6407.
146. Yaghi, 0. M.; et al, Hydrothermal Synthesis of a Metal-Organic Framework Containing Large Rectangular Channels. J. Am. Chem. Soc. 1995, 117 (41), 10401-10402.
147. Yang, Z. W.; et al. Fabrication of Ce doped UiO-66/graphene nanocomposites with enhanced visible light driven photoactivity for reduction of nitroaromatic compounds. Appl. Surf. Sci. 2017, 420, 276-285.
148. Yi, P.; et al, A series of europium-based metal organic frameworks with tuned intrinsic luminescence properties and detection capacities. RSC Advances 2016, 6 (113), 111934-111941.
149. Yoshinori, U.; et al, X-Ray Photoelectron Spectroscopy of Rare Earth Halides. Bull. Chem. Soc. Jpn. 1986, 59 (7), 2263-2267.
150. Yu, L. et al, J. Am. Chem. Soc., 2022, 144, 3766-3770.
151. Zalkin, A. et al, J. Am. Chem. Soc., 1953, 75, 2453-2458.
152. Zhang, L. et al, Angew. Chem., Int. Ed., 2018, 57, 5095-5099.
153. Zhang, R.; et al. α-Fe2O3 nanoclusters confined into UiO-66 for efficient visible-light photodegradation performance. Appl. Surf. Sci. 2019, 466, 956-963.
154. Zhang, Y.; et al, Robust Bifunctional Lanthanide Cluster Based Metal-Organic Frameworks (MOFs) for Tandem Deacetalization-Knoevenagel Reaction. Inorg. Chem. 2018, 57 (4), 2193-2198.
155. Zhang, Y. F. et al, Inorg. Chem., 2020, 59, 11233-11237.
156. Zhang, Z.; et al. A Comparative Study on the Structure and Catalytic Performance of UiO-66 Supported Pt Nanocatalysts Prepared by NaBH4 and H2 Reduction: Light-Off, Durability and Mechanism for CO Oxidation. J. Inorg. Organomet. Polym. Mater. 2020, 30 (11), 4350-4360.
157. Zhao, X. et al, Science, 2004, 306, 1012-1015.
158. Zhao, X.-Y.; et al, Facile fabrication of Eu-1,4-NDC-fcu-MOF particles for sensing of benzidine. Main Group Chem. 2020, 19, 117-124.
159. Zhou, H. C. et al, Chem. Rev., 2012, 112, 673-674.
160. Zhu, L. et al, Chem. Rev., 2017, 117, 8129-8176.

What is claimed is:

1. A method for extracting one or more fluorine atoms from an organo-fluorine molecule, the method comprising contacting rare earth (RE) metal ions with the organo-fluorine molecule.

2. The method of claim 1, wherein the organo-fluorine molecule comprises a perfluoroalkyl or polyfluoroalkyl substances (PFAS), a benzoic acid derivative comprising at least one fluorine substituent, or any combination thereof.

3. The method of claim 2, wherein the at least one PFAS comprises perfluorooctanoic acid, perfluorohexanoic acid, or any combination thereof.

4. The method of claim 2, wherein the benzoic acid derivative comprising at least one fluorine substituent comprises 2-fluorobenzoic acid (2-FBA), 2,6-difluorobenzoic acid (2,6-DFBA), or any combination thereof.

5. The method of claim 1, wherein the RE metal ions comprise Ho³⁺, Gd³⁺, Eu³⁺, Dy³⁺, Y³⁺ or any combination thereof.

6. The method of claim 1, further comprising contacting the RE metal ions and the organo-fluorine molecule with a ligand.

7. The method of claim 1, wherein the ligand comprises 2,2′-bipyridine, 1,3,5-tris(4-carboxyphenyl)-benzene (H₃BTB), bicinchoninic acid (BCA), or any combination thereof.

8. The method of claim 1, wherein the method is conducted in a solvent.

9. The method of claim 8, wherein the solvent comprises N,N′-dimethylformamide (DMF), N,N′-diethylformamide (DEF), dimethylacetamide (DMAC), or any combination thereof.

10. The method of claim 9, wherein the solvent further comprises water, hydrogen peroxide (H₂O₂), acetic acid, HNO₃, or any combination thereof.

11. The method of claim 1, wherein the method produces a fluorinated RE metal organic framework (MOF).

12. A method for synthesizing a fluorinated rare earth metal organic framework (MOF), the method comprising contacting a rare earth (RE) metal ion with an organo-fluorine molecule and an organic ligand.

13. The method of claim 12, wherein the organo-fluorine molecule comprises perfluorooctanoic acid, perfluorohexanoic acid, 2-fluorobenzoic acid (2-FBA), 2,6-difluorobenzoic acid (2,6-DFBA), or any combination thereof.

14. The method of claim 12, wherein the RE metal ion comprises Ho³⁺, Gd³⁺, Eu³⁺, Dy³⁺, Y³ or any combination thereof.

15. The method of claim 12, wherein the organic ligand comprises 1,3,5-tris(4-carboxyphenyl)-benzene (H₃BTB), bicinchoninic acid (BCA), or any combination thereof.

16. The method of claim 12, wherein the RE metal ion comprises Gd³⁺ or Ho³⁺ and the organic ligand comprises H₃BTB.

17. The method of claim 12, wherein the RE metal ion comprises Y³⁺ and the organic ligand comprises BCA.

18. A fluorinated rare earth metal organic framework (MOF) produced by the method of claim 12.

19. The fluorinated rare earth MOF of claim 18, wherein the RE metal ion comprises Gd³⁺ or Ho³⁺ and the rare earth MOF comprises a hexagon-shaped crystal comprising 15-c nonanuclear and 9-c trinuclear cluster MOFs.

20. The rare earth MOF of claim 18, wherein the RE metal ion comprises Y³⁺ and the rare earth MOF comprises a tetragon-shaped crystal comprising hexanuclear clusters.
